(19) United States
(12) Patent Application Publication
(10) Pub. No.: US 2014/0210741 A1
(43) Pub. Date: Jul. 31, 2014

(54) INFORMATION PROCESSING APPARATUS AND TOUCH PANEL PARAMETER CORRECTING METHOD

(71) Applicant: FUJITSU LIMITED, Kawasaki-shi (JP)

(72) Inventors: Haruna KOMATSU, Kawasaki (JP); Takuma YAMADA, Kawasaki (JP)

(73) Assignee: FUJITSU LIMITED, Kawasaki-shi (JP)

(21) Appl. No.: 14/090,601

(22) Filed: Nov. 26, 2013

(30) Foreign Application Priority Data
Jan. 25, 2013 (JP) 2013-011845

(51) Int. Cl. G06F 3/041

(52) U.S. Cl. CPC G06F 3/0416
USPC 345/173

(57) ABSTRACT

An information processing apparatus includes a touch panel; an item to get a screen previous to a present screen to be displayed on the touch panel, and a control unit to execute process of storing, when a tap operation on the touch panel or an operation to the item is performed, operation history information indicating a type and time of the performed operation on a storage unit; specifying an operation sequence in which a time interval between a first operation and a second operation is equal to or smaller than a specified period, and the first operation is the tap operation, the second operation is the operation to the item and a third operation is the tap operation are conducted on the basis of operation history information on the storage unit, and updating a correction quantity of tap coordinates on the basis of the specified operation sequence.

### CROSS-REFERENCE TO RELATED APPLICATION

This application is based upon and claims the benefit of priority of the prior Japanese Patent Application No. 2013-011845, filed on Jan. 25, 2013, the entire contents of which are incorporated herein by reference.

### FIELD

The present invention relates to an information processing apparatus, a touch panel parameter correcting method and a computer-readable recording medium.

### BACKGROUND

Over the recent years, there have been an increased number of information processing apparatuses (smartphone, tablet PC (Personal Computer)) configured to perform an operation by tapping a touch panel (touch screen), however, a way of how to tap the touch panel is different on a user-by-user basis. To be specific, there exist a user having a tendency to tap a lower portion of an object displayed on the touch panel and also a user having a tendency to tap, by contrast, an upper portion of the object. Further, there exist a user who performs double-tapping very fast and a user unable to perform the double-tapping fast.

Therefore, an information processing apparatus equipped with the touch panel (which will hereinafter be simply referred to as the information processing apparatus) is normally provided with a function of setting and adjusting an associative relation between a region touched by a finger of the user and tap coordinates. Moreover, the information processing apparatus is also provided with a function of setting and adjusting a time threshold for determining a type of the tap operation.

Each of the functions possessed by a general type of information processing apparatus is, however, a function disabled from setting a parameter related to the touch panel (which will hereinafter be termed a touch panel parameter) unless a dedicated setting screen is displayed. In other words, the function of setting (adjusting) the general touch panel parameter is absolutely useless to users who do not know that the variety of touch panel parameters can be set and adjusted.

Further, the setting function related to the thresholds of the existing information processing apparatus is a function disabled from properly setting the threshold unless repeating an operation such as “changing the threshold through an operation of “slider” etc., and checking whether or not the threshold is correctly changed by performing the double-tapping etc.”

### PRIOR ART DOCUMENTS

Patent Document 1: Japanese Laid-Open Publication No. 2003-288172

### SUMMARY

According to an aspect of the embodiments, an information processing apparatus includes: a touch panel; an item to get a screen previous to a screen at a present point of time to be displayed on the touch panel; an operation history information storage unit; and a control unit to execute an application utilizing the touch panel as an input/output device, wherein the control unit executes: an operation history storing process of storing, when a tap operation on the touch panel or an operation to the item is performed, operation history information indicating a type of the performed operation and time when the operation is performed on the operation history information storage unit; and a touch panel parameter update process of specifying an operation sequence in which a time interval between a first operation and a second operation is equal to or smaller than a specified period of time and in which the first operation defined as the tap operation, the second operation defined as the operation of the item and a third operation defined as the tap operation are conducted in this sequence, from within the operation sequences conducted by a user on the basis of pieces of operation history information stored on the operation history information storage unit, and updating a correction quantity of tap coordinates of the tap operation performed on the touch panel on the basis of the result of specifying the operation sequence.

According to another aspect of the embodiments, a touch panel parameter update method of an information processing apparatus including a touch panel and an item to get a screen previous to a screen at a present point of time to be displayed on the touch panel, a processor executing: storing, when the tap operation on the touch panel or an operation to the item is performed, operation history information indicating a type of the performed operation and time when the operation is performed on an operation history information storage unit; specifying an operation sequence in which a time interval between a first operation and a second operation is equal to or smaller than a specified period of time and in which the first operation defined as the tap operation, the second operation defined as the operation of the item and a third operation defined as the tap operation are conducted in this sequence, from within the operation sequences conducted by the user on the basis of the operation history information stored on the operation history information storage unit; and updating a correction quantity of the tap coordinates of the tap operation performed on the touch panel on the basis of the result of specifying the operation sequence.

According to still another aspect of the embodiments, a computer-readable recording medium having stored therein a program for causing an information processing apparatus including a touch panel, an item to get a screen previous to a screen at a present point of time to be displayed on the touch panel and a storage device to execute a process including: storing, when a tap operation on the touch panel or an operation to the item is performed, operation history information indicating at least a type of the performed operation and time when the operation is performed on the storage device; specifying an operation sequence in which a time interval between a first operation and a second operation is equal to or smaller than a specified period of time and in which the first operation defined as the tap operation, the second operation defined as the operation of the item and a third operation defined as the tap operation are conducted in this sequence, from within the operation sequences conducted by a user on the basis of pieces of operation history information stored on the storage device; and correcting a coordinates correction value for specifying a correction quantity of tap coordinates of the tap operation performed on the touch panel on the basis of the result of specifying the operation sequence.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram of a schematic configuration of an information processing apparatus according to a first embodiment;

FIG. 2 is a diagram of an external appearance of the information processing apparatus according to the first embodiment;

FIG. 3 is an explanatory diagram of correction information according to the first embodiment;

FIG. 4 is an explanatory diagram of an analysis result table according to the first embodiment;

FIG. 5 is a flowchart of an operation distinguishing process according to the first embodiment;

FIG. 6 is an explanatory diagram of an operation history table according to the first embodiment;

FIG. 7 is a flowchart of a correction information update process according to the first embodiment;

FIG. 8 is a flowchart of a coordinates correction information generating process according to the first embodiment;

FIG. 9 is an explanatory diagram of an operation example of a user in the case of mis-recognizing a tapping destination;

FIG. 10 is an explanatory diagram of the operation example of the user in the case of mis-recognizing the tapping destination;

FIG. 11 is a flowchart of a long tap threshold correction information generating process according to the first embodiment;

FIG. 12 is an explanatory diagram of a function of an application program for displaying a thumbnail screen of photos;

FIG. 13 is an explanatory diagram of an operation example of the user in the case of mis-recognizing a type of the tap operation;

FIG. 14 is a flowchart of a double tap threshold correction information generating process according to the first embodiment;

FIG. 15 is a diagram of a schematic configuration of an information processing apparatus according to a second embodiment;

FIG. 16 is an explanatory diagram of an operation history table according to the second embodiment;

FIG. 17 is an explanatory diagram of an analysis result table according to the second embodiment;

FIG. 18 is an explanatory diagram of system purposed correction information according to the second embodiment;

FIG. 19 is an explanatory diagram of application-by-application correction information according to the second embodiment;

FIG. 20 is a flowchart of an operation distinguishing process according to the second embodiment;

FIG. 21 is a flowchart of a tap object specifying process;

FIG. 22 is a flowchart of an interval setting process;

FIG. 23 is an explanatory diagram of an associative relation between interval thresholds and combinations of event types;

FIG. 24 is a flowchart of a correction information update process according to the second embodiment;

FIG. 25A is an explanatory diagram (part 1) of content of a table translation process;

FIG. 25B is an explanatory diagram (part 2) of the content of the table translation process;

FIG. 25C is an explanatory diagram (part 3) of the content of the table translation process;

FIG. 26A is an explanatory diagram (part 1) of content of the table translation process;

FIG. 26B is an explanatory diagram (part 2) of the content of the table translation process;

FIG. 27 is a flowchart of a coordinates correction information generating process according to the second embodiment;

FIG. 28 is a flowchart of a long tap threshold correction information generating process according to the second embodiment;

FIG. 29 is a flowchart of the long tap threshold correction information generating process according to the second embodiment; and

FIG. 30 is an explanatory diagram of functions of the information processing apparatus according to the second embodiment.

### DESCRIPTION OF EMBODIMENTS

In-depth descriptions of two embodiments of the present invention will hereinafter be made with reference to the drawings. It is to be noted that a configuration of an information processing apparatus and a processing procedure of a CPU (Central Processing Unit) within the information processing apparatus according to each of the embodiments of the present invention, which will hereinafter be described, do not, unless otherwise specified, have any such gist that the technical scope of the present invention is limited to only those described above.

### First Embodiment

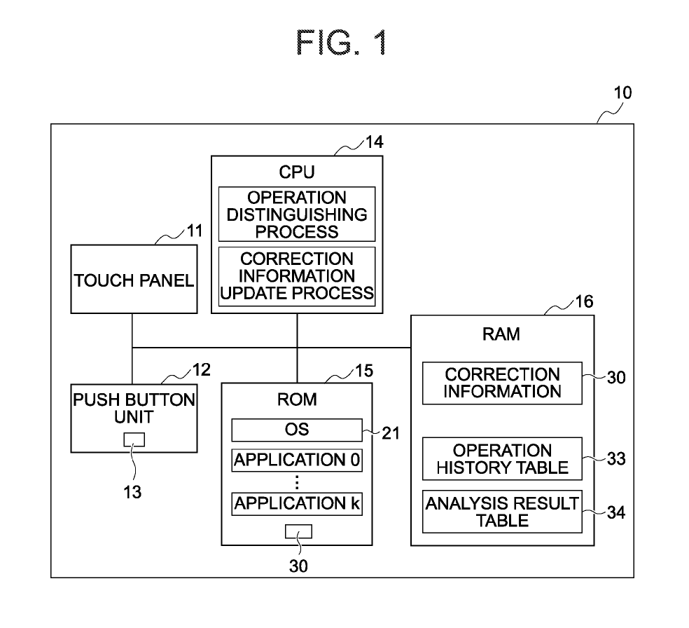

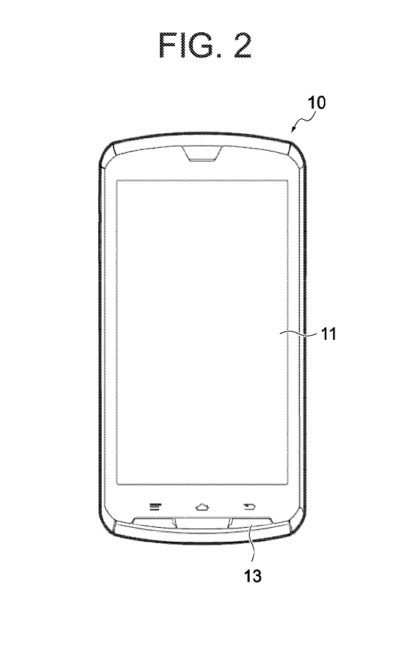

FIGS. 1 and 2 respectively illustrate a schematic diagram of a configuration and a view of an external appearance of an information processing apparatus 10 according to a first embodiment.

As illustrated in FIG. 1, the information processing apparatus 10 according to the first embodiment includes a touch panel 11, a push button unit 12, a CPU (Central Processing Unit) 14, a ROM (Read Only Memory) 15 and a RAM (Random. Access Memory) 16. Note that the information processing apparatus 10 is an apparatus realized (manufactured) by changing an OS (Operating System) of an existing smartphone into an OS 21. Accordingly, the information processing apparatus 10 also includes, though not depicted in FIG. 1, a proximity sensor, an illuminance sensor, an attitude sensor, a microphone, a loud speaker, a camera, a wireless communication circuit, etc.

The touch panel 11 is a unit referred to also as a touch screen configured to dispose a transparent position input device on a liquid crystal panel (liquid crystal display). As illustrated in FIG. 2, this touch panel 11 has a size that substantially covers a front surface of a housing of the information processing apparatus 10.

The push button unit 12 (FIG. 1) is a unit including, as components thereof, several push buttons (key switches) provided in the information processing apparatus 10. This push button unit 12 includes a back button 13 (see FIG. 2) pressed by a user when returning a screen displayed on the touch panel 11 to a previous screen. More precisely, the push button unit 12 includes the “back button 13” pressed for returning contents displayed on the touch panel 11 to those displayed before a tap operation (or the operation of pressing the back button 13) of the last time. The operation of pressing the back button 13 will hereinafter be termed a “cancelling operation.”

The ROM 15 is a rewritable nonvolatile storage device (which is a flash ROM in the first embodiment) stored with a variety of application programs (which will hereinafter be simply written as “applications”), correction information 30, etc. This ROM 15 is also stored with a driver for the touch panel 11 (which will hereinafter be referred to as a touch panel driver), a driver for the push button unit 12 and so on.

The RAM 16 is a volatile storage device onto which the variety of programs (OS 21, the drivers and the applications) executed by the CPU 14 are loaded from the ROM 15. During the operation of the information processing apparatus 10, this RAM 16 gets stored with the correction information 30, an operation history table 33 and an analysis result table 34 together with the variety of programs executed by the CPU 14.

The CPU 14 is a unit that performs various processes according to the variety of programs on the RAM 16.

The OS 21 is a program as an improved version of the existing OS (corresponding to Android which is a Linux-based OS and is Trademark or Registered Trademark of Google Inc. in the first embodiment) so that a long tap threshold and a double tap threshold are automatically changed to values more suited to a user. Further, the OS 21 is also the program as the improved version of the existing OS so that a tap coordinates correction value is automatically changed to a value more suited to the user.

Herein, the “long tap threshold” (which will hereinafter be also abbreviated to the LT threshold) connotes time information for defining a shortest period of tap time of the long tap operation. Concretely, the tap operation is classified into a single tap operation of which the tap time is comparatively short, long tap operations of which the tap time is comparatively long and a double tap operation in which the single tap operation is repeated twice for a short period of time. The CPU 14 determines whether a certain tap operation is the long tap operation or the single tap operation on the basis of whether the tap time of the tap operation is equal to or larger than the LT threshold. Note that the tap time connotes a period of time for which the user's finger remains touching the touch panel 11. The tap time is specified (detected) by the touch panel driver.

The double tap threshold (which will hereinafter be also abbreviated to the DT threshold) connotes time information for defining a longest time interval of the two single-tap operations during the double tap operations. Namely, the CPU 14, when the single tap operation is performed, monitors if the next tap operation is conducted during a period of time indicated by this DT threshold in order to determine whether this operation is the first single tap operation of the double tap operations or not.

The “tap coordinates correction value” connotes an x-directional correction value and a y-directional correction value that are added to the tap coordinates detected by the touch panel driver in order to calculate the tap coordinates for specifying an object (button etc.) on the touch panel 11 tapped by the user.

A configuration and an operation of the information processing apparatus 10 according to the first embodiment will hereinafter be described more concretely.

To begin with, an operation of the information processing apparatus 10 when being started up will be described.

Upon power-on of the information processing apparatus 10, the CPU 14 loads the OS 21 and some number of drivers onto the RAM 16 from the ROM 15, and starts operating according to the respective programs. The CPU 14, sr which has started operating based on the OS 21, initiates a startup process, then reads the correction information 30 from the ROM 15 and stores the correction information 30 in the RAM 16.

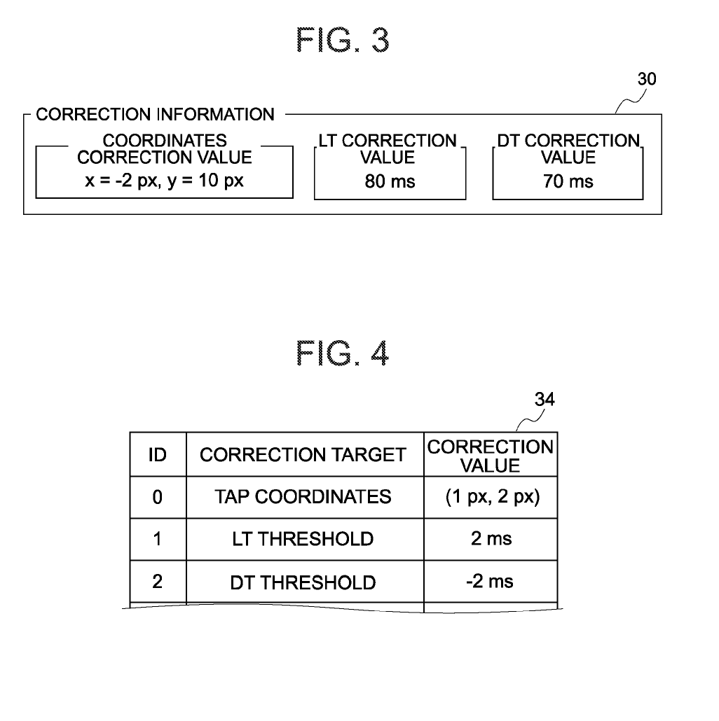

FIG. 3 illustrates a structure (data structure) of the correction information 30. As illustrated in FIG. 3, the correction information 30 contains a coordinates correction value defined as the tap coordinates correction value, an LT correction value as the correction value of the LT (long tap) threshold, and a DT correction value as the correction value of the DT (double tap) threshold. Note that the correction information 30 stored in the ROM 15 of the information processing apparatus 10 immediately after being manufactured is the information of which an LT correction default value and a DT correction default value are all zeros. Further, the CPU 14 (OS 21) writes the correction information 30 on the RAM 16 back to the ROM 15 if power-off of the information processing apparatus 10 occurs, etc.

The coordinates correction value, the LT correction value and the DT correction value in the correction information 30 are essentially the same as items of information used for correcting the tap coordinates, the LT threshold and the DT threshold in a general type of information processing apparatus. However, the respective correction values in the correction information 30 are not values set by the user while displaying a setting screen but values that are automatically updated to become the values more suited to the user on the basis of a history of the user's operations about the touch panel 11 and the back button 13.

The CPU 14, which has read the correction information 30 onto the RAM 16, calculates the LT threshold and the DT threshold in the following formulae that are used in an operation distinguishing process to be executed after completing the startup process.

LT threshold=LT standard threshold+LT correction value in correction information 30
DT threshold=DT standard threshold+DT correction value in correction information 30

Herein, the LT standard threshold connotes a value that is preset as a default value of the LT threshold. Similarly, the DT standard threshold connotes a value that is preset as a default value of the DT threshold.

The CPU 14 having finished calculating the LT threshold and the DT threshold prepares (generates), on the RAM 16, an empty operation history table 33 and an empty analysis result table 34 each stored with none of significant records.

The analysis result table 34 is a table having the structure (data structure) illustrated in FIG. 4 and used in a correction information update process executed by the CPU 14 after completing the startup process.

An “ID” field in this analysis result table 34 is a field in which a “record number before adding records on the analysis result table 34” is set as “ID” (identifier) of each record. A “CORRECTION VALUE” field is a field in which to set the correction value for the tap coordinates, or for the LT threshold or for the DT threshold, of which details will be described later on.

A “CORRECTION TARGET” field is a field in which to set a correction target identifier for specifying which target value, the tap coordinates, or the LT threshold or the DT threshold, is corrected by the correction value set in the “CORRECTION VALUE” field. In the following discussion, the correction target identifiers for specifying the tap coordinates, the LT threshold and the DT threshold, which are corrected by the correction values set in the “CORRECTION VALUE” field, will be termed “tap coordinates”, “DT threshold” and “LT threshold”, respectively. Moreover, in the analysis result table 34, records containing the “tap coordinates”, “DT threshold” and “LT threshold” set in the “CORRECTION TARGET” field are referred to as a coordinates correction purposed record, a DT threshold correction purposed record and an LT threshold correction purposed record, individually.

The operation history table 33 is a table to which a record indicating content of the operation conducted by the user is added each time the user performs the tap operation and the cancelling operation. An in-depth description of this operation history table 33 will be made later on together with content of the operation distinguishing process.

The CPU 14, which has prepared the empty operation history table 33 and the empty analysis result table 34 on the RAM 16, finishes the startup process. Then, the CPU 14 comes to a status of executing a correction information update process while carrying out the operation distinguishing process whenever a predetermined start condition is satisfied.

At first, content of the operation distinguishing process will be described. Note that in the following discussion, the tap coordinates detected by the touch panel driver will be termed a detected coordinates in order to facilitate a distinction between the tap coordinates before and after adding the coordinates correction value.

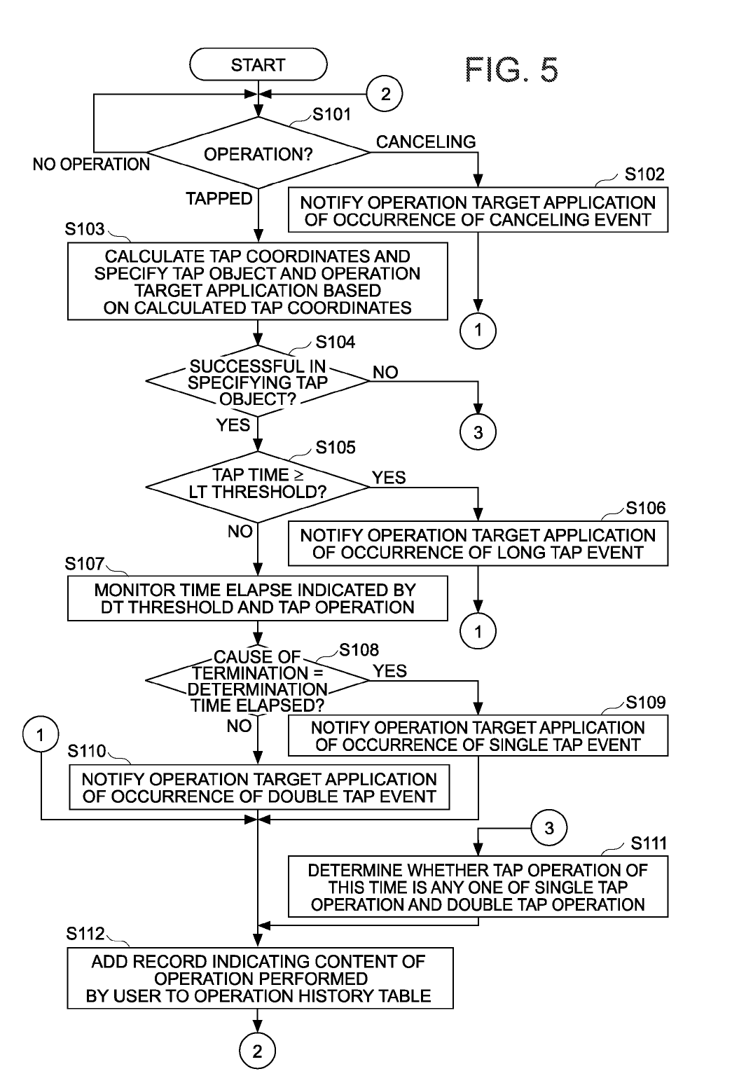

FIG. 5 illustrates a flowchart of the operation distinguishing process. This operation distinguishing process is a process of grasping, on a per user's operation basis, the content of the operation, notifying the applications of the grasped content of the operation and recording the grasped content in the operation history table 33.

As depicted in FIG. 5, the CPU 14 executing the operation distinguishing process normally monitors if the tap operation or the cancelling operation on the basis of the information given from the touch panel driver and the driver for the push button unit 12 (step S101; no operation).

In step S101, items of information obtained by the CPU 14 (OS 21) from the touch panel driver are the tap time and the detected coordinates. Further, the tap operations each becoming a processing monitor target in step S101 are the single tap operation and the long tap operation. An actual determination as to which tap operation has been performed by the user is made not in step S101 but in step S105, step S108 or step S111.

The CPU 14, if the tap operation is performed (step S101; tapped), calculates the tap coordinates by adding the coordinates correction value in the correction information 30 (FIG. 3) on the RAM 16 to the detected coordinates in step S103. Furthermore, the CPU 14 specifies the object tapped by the tap operation of this time (which will hereinafter be referred to as a tap object) on the basis of the calculated tap coordinates. Then, the CPU 14, after specifying the application on which the tap object is displayed on the screen (window) of itself, finishes the process in step S103.

Note that the object specified as the tap object by the CPU 14 in step S103 is basically a graphic form or a character string displayed on the touch panel 11 by the CPU 14 in accordance with one or a plurality of applications in execution underway. If in such a case that the object recognized to be tapped from the tap coordinates is not the object about which notification of being tapped is not requested by the application (s), however, the CPU 14 does not specify this object as the tap object. In this case, the CPU 14, after specifying the application with this object being displayed as an operation target application, finishes the process in step S103.

The CPU 14 having finished the process in step S103, if succeeding in specifying the tap object (step S104; YES), determines whether or not the tap time of the tap operation of this time is equal to or larger than the LT threshold (step S105). Namely, the CPU 14 determines whether or not the tap time obtained from the touch panel driver is equal to or larger than the already-calculated value given by “LT standard threshold +LT threshold” (step S105).

If the tap time is equal to or larger than the LT threshold (step S105; YES), the CPU 14 notifies the operation target application, specified in step S103, of occurrence of a long tap event (step S106). Herein, a phrase “notifying the operation target application of the occurrence of the single/long/double tap event” implies “notifying the operation target application that the object specified in the process of step S103 is single/long/double-tapped”.

The CPU 14 having finished the process in step S106 adds a record indicating the content of the operation performed by the user this time to the operation history table 33 (step S112; details will be described later on).

Whereas if the tap time is equal to or smaller than the LT threshold (step S105; NO), the CPU 14 executes the following process in step S107.

The CPU 14 executes, to start with, a process of monitoring if a period of time (which will hereinafter be termed “determination time”) indicated by the DT threshold elapses and if the finger touches the touch panel 11. Then, the CPU 14, if the determination time elapses without the finger touching the touch panel 11, finishes the process in step S107.

Further, the CPU 14, if the finger touches the touch panel 11 before the elapse of the determination time, stores the elapse time after starting the process in step S107 as a tap interval. Then, the CPU 14 stands by for completion of the tap operation (till the finger gets separated from the touch panel 11) and, when completing the tap operation, terminates the process in step S107.

The CPU 14 having finished the process in step S107 notifies, if this process is finished due to the elapse of the determination time (step S108; YES), the operation target application of the occurrence of the single tap operation (step S109). Further, the CPU 14 notifies, if the process in step S107 is finished due to the tap operation being performed (step S108; NO), the operation target application of the occurrence of the double tap event (step S110).

The CPU 14, which has finished the process in step S109 or S110, adds the record indicating the content of the operation performed by the user this time to the operation history table 33 (step S112).

Further, the CPU 14, if failing in specifying the tap object (step S104; NO), determines whether the tap operation of this time is the single tap operation or the long tap operation (step S111). That is, in this step S111, the CPU 14 determines whether or not the tap time of the tap operation of this time is equal to or larger than the LT threshold.

Then, the CPU 14 adds the record indicating the content of the operation performed by the user this time to the operation history table 33 (step S112).

Moreover, the CPU 14 notifies, if the cancelling operation is conducted (step S101; cancelled), the operation target application of the occurrence of the cancelling event (step S102). Namely, the CPU 14 notifies the operation target application that the back button 13 is pressed. Then, the CPU 14 adds the record indicating the content of the operation performed by the user this time to the operation history table 33 (step S112).

Content of the process in step S112 will be specifically described.

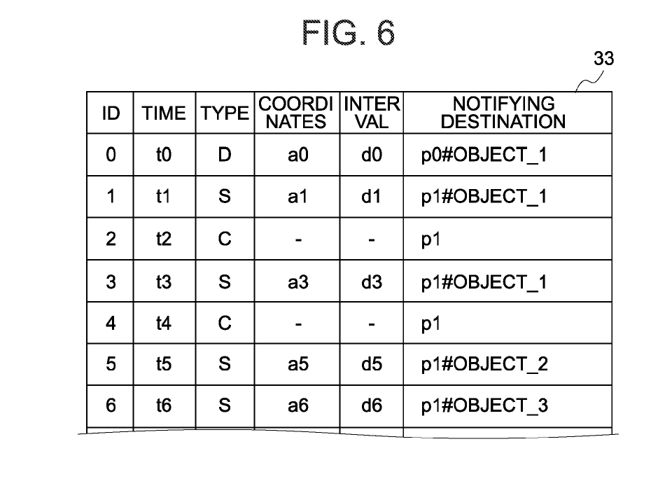

FIG. 6 illustrates a structure (data structure) of the operation history table 33.

As illustrated in FIG. 6, the operation history table 33 contains an “ID” field, a “TIME” field, a “TYPE” field, a “COORDINATES” field, and an “INTERVAL” field and a “NOTIFYING DESTINATION” field.

When in the process of step S112, the CPU 14 adds records containing the following values set in the respective fields to this operation history table 33. Note that in the following discussion, an S operation, an L operation, a D operation and a C operation represent the single tap operation, the long tap operation, the double tap operation and the cancelling operation, respectively. Further, a record adding target operation connotes an operation determined to be performed by the user when in the process of step S101, step S105, step S108 or step S111.

[“ID” Field]

The “ID” field is entered with the record number before adding the record on the operation history table 33.

[“TIME” Field]

The “TIME” field is entered with the time when completing the record adding target operation that is expressed by “the elapse time being time-stamped on a millisecond basis counted from 00:00:00 a.m. Jan. 1 1970 according to Coordinated Universal Time (UTC)” (which will hereinafter be referred to as operation time).

[“TYPE” Field]

The “TYPE” field is entered with the operation types as follows: a case of the record adding target operation being the S operation: an operation type “S” indicating that a self-record is the record related to the S operation;

a case of the record adding target operation being the D operation: an operation type “D” indicating that the self-record is the record related to the D operation;
a case of the record adding target operation being the L operation: an operation type “L” indicating that the self-record is the record related to the L operation; and
a case of the record adding target operation being the C operation: an operation type “C” indicating that the self-record is the record related to the C operation.

It is to be noted that the operation types (S, D, L, C) set in this “TYPE” field may be characters representing S etc. and may also be information indicating S etc.

[“COORDINATES” Field]

The “COORDINATES” field is entered with the tap coordinates and NULL (no entry) as follows:

a case of the record adding target operation being the tap operation (S operation, L operation or D operation): tap operation; and a case of the record adding target operation being the C operation: NULL.

[“INTERVAL” Field]

The “INTERVAL” field is entered with the tap time, the tap interval and NULL as follows:

a case of the record adding target operation being the S operation or the L operation; tap time;
a case of the record adding target operation being the D operation: tap interval; and
a case of the record adding target operation being the C operation: NULL.

[“NOTIFYING DESTINATION” Field]

The “NOTIFYING DESTINATION” field is entered with the following information:

a case of the tap object not being specified: identifying information of the operation target application (“p0”, “p1” in FIG. 6, which will hereinafter be referred to as operation target application names); and
a case of the tap object being specified; the operation object application name and the tap object identifying information (“object 1” etc. in FIG. 6).

Note that this “NOTIFYING DESTINATION” field is a field that is not referred to by the information processing apparatus 10 according to the first embodiment.

In step S112 (FIG. 5), the CPU 14 adds the records having the contents described above to the operation history table 33. Then, the CPU 14 having finished the process in step S112 restarts the processes from step S101 onward.

Next, a start condition of the correction information update process will be described.

The CPU 14, while executing the operation distinguishing process having the content described above, monitors if the number of records (record count) on the operation history table 33 (FIG. 6) becomes equal to or larger than a predetermined count and if the elapse time after completing the correction information update process of the last time becomes equal to or longer than a predetermined period of time. Then, the CPU 14 starts the correction information update process when the record count on the operation history table 33 becomes equal to or larger than the predetermined count and when the predetermined time elapses with the record count not becoming equal to or larger than the predetermined count, and comes to a status of executing the operation distinguishing process and the correction information update process in parallel.

Next, content of the correction information update process will be described.

At the first onset, some number of terminologies used for the following discussion will be defined.

In the following discussion, on the operation history table 33 (FIG. 6), a record with the operation type being notated by “X” (=S, C, etc.) is termed an X record (an S record, a C record, etc.). Further, on the operation history table 33, N-number (=3 or 4) of records with the “ID” values being continuous are also termed a first record through an N-th record in the sequence from the smallest of the “ID” value down to the largest. Moreover, on the operation history table 33, the records with the “ID” values smaller and larger by “1” than an “ID” value of a certain record α are referred to as the record previous to the record α and the record next to the record α, respectively.

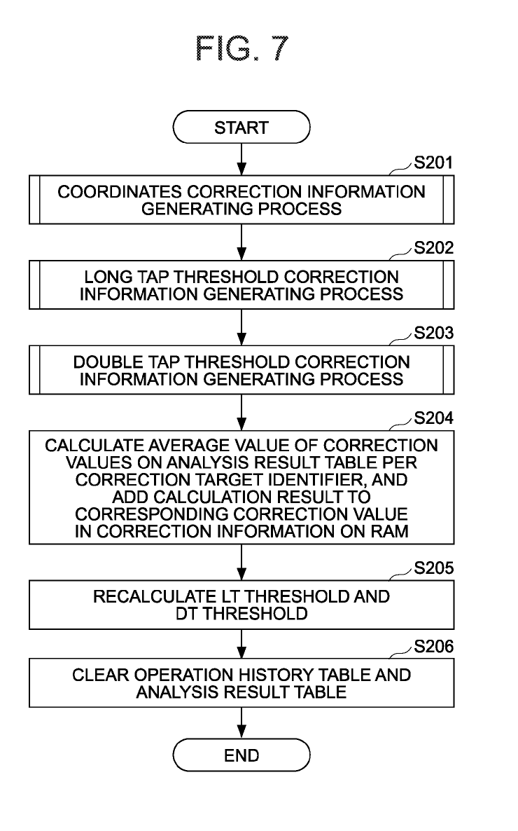

FIG. 7 illustrates a flowchart of the correction information update process.

As depicted in FIG. 7, the CPU 14 starting the correction information update process executes a coordinates correction information generating process (step S201), an LT threshold correction information generating process (step S202) and a DT threshold correction information generating process (step S203).

The coordinates correction information generating process is basically a process of iterating a series of following processes till “the three operations performed by the user due to mis-recognition of the tapping destination gets disabled from being specified.

The three operations performed by the user due to the tapping destination being mis-recognized are specified based on the information on the operation history table 33.

The correction value to be added to the coordinates correction value in the correction information 30 is calculated based on the contents of the specified three operations.

The coordinates correction purposed record in which the calculated correction value is set, is added to the analysis result table 34.

Then, the coordinates correction information generating process is a process of specifying the three operations performed due to the mis-recognition of the tapping destination by exploiting such a practice that “if the tapping destination is mis-recognized, the user normally redoes the tap operation within a short period of time after performing the cancelling operation within the short time”.

Content of the coordinates correction information generating process will hereinafter be described in detail. Note that in the following discussion, after temporarily explaining a procedure of the coordinates correction information generating process with the aid of a flowchart, the content of the coordinates correction information generating process will be described more specifically by use of concrete operation examples.

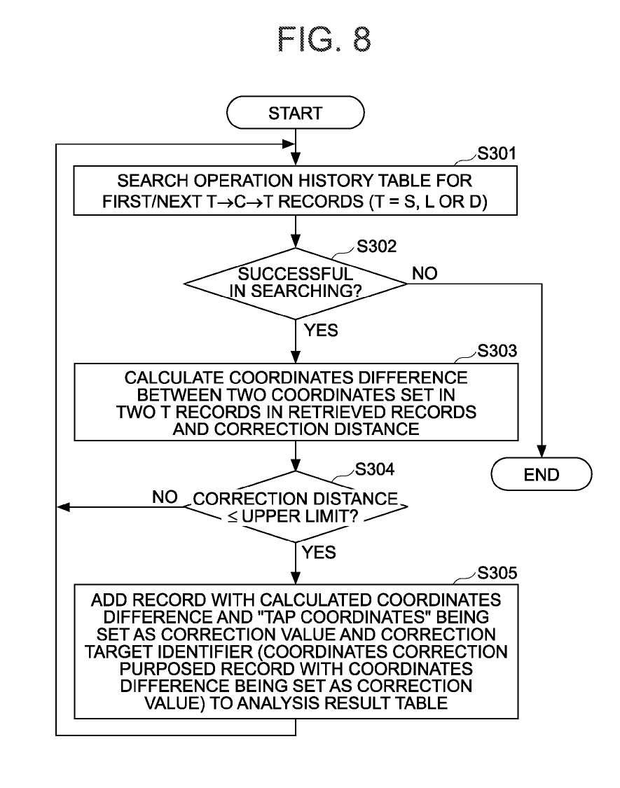

FIG. 8 depicts a flowchart of the coordinates correction information generating process.

As depicted in FIG. 8, the CPU 14 starting the coordinates correction information generating process searches at first the operation history table 33 for first T→C→T records (S→C→S records, L→C→L records or D→C→D records) (step S301).

The T→C→T records searched for in this step S301 (T=S, L or D) are three records with the “ID” values being continuous on the operation history table 33, in which the operation types of the first through third records are T, C and T, respectively. Further, the T→C→T records satisfy the following conditions 1 and 2.

The condition 1: Operation time of Second Record−Operation Time of First Record≦First Predefined Time

The condition 2: Operation Time of Third Record−Operation Time of Second Record≧Second Predefined Time

Herein, each of the first predefined time and the second predefined time connotes a preset period of time (the first predefined time is 2 sec, and the second predefined time is 3 sec in the first embodiment).

Note that though the detailed description is omitted, the process in step S301 is a process of searching for a single set of T→C→T records in the following procedures.

(1) The first record is determined by searching for the T record, and the operation time of the determined first record is gasped.
(2) A record next to the first record is specified as the second record, and the operation time and the operation type of the second record are grasped.
(3a) If the operation type of the second record is not “C” or if the condition 1 is not established with respect to the operation time of each of the first and second records, the process is redone from the procedure (1).
(3b) If the operation type of the second record is “C” and if the condition 1 is established with respect to the operation time of each of the first and second records, a record next to the second record is specified as the third record, and the operation time and the operation type of the third record are grasped.
(4a) If the operation type of the third record is not coincident with the operation type of the first record or if the condition 2 is not established with respect to the operation time of each of the second and third records, the process is redone from the procedure (1).
(4b) If the operation type of the third record is coincident with the operation type of the first record and if the condition 2 is established with respect to the operation time of each of the second and third records, the first through third records are set as a result of the search for the T→C→T records.

If the T→C→T records can be searched for (step S302; YES), the CPU 14 calculates a coordinates difference between the two coordinates set in the two T records in the T→C→T records and a correction distance as a distance between these two coordinates (step S303). The coordinates difference calculated by the CPU 14 in this step is a value given by subtracting the coordinates of the first record from the coordinates of the third record. In other words, the coordinates difference calculated by the CPU 14 in step S303 is a value given by subtracting the coordinates of the T record having the smaller “ID” value from the coordinates of the T record having the larger “ID” value in the retrieved T→C→T records.

The CPU 14 having finished the process in step S303 compares the calculated correction distance with a correction distance upper limit (given as the upper limit in FIG. 8) (step S304). Herein, the “correction distance upper limit” connotes a value representing a length of approximately several millimeters (e.g., 3 mm) when converted into a preset length of the unit of “mm”.

If the correction distance is larger than the correction distance upper limit (step S304; NO), the CPU 14 returns to step S301 and searches the operation history table 33 for the next T→C→T records.

Whereas if the correction distance is equal to or smaller than the correction distance upper limit (step S304; YES), the CPU 14 adds, to the analysis result table 34 (FIG. 4), the coordinates correction purposed record in which the calculated coordinates difference is set as the correction value (step S305). More specifically, the CPU 14 adds, to the analysis result table 34, the records in which the “record number” before adding the record on the analysis result table 34, the “tap coordinates” and the calculated coordinates difference are set in the “ID” field, the “CORRECTION TARGET” field and the “CORRECTION VALUE” field, respectively.

The CPU 14 having finished the process in step S305 loops back to step S301 and searches the operation history table 33 for the next T→C→T records.

The CPU 14 repeats the same process till failing in searching for the T→C→T records, in other words, till the unprocessed T→C→T records disappear. Then, the CPU 14, when the unprocessed T→C→T records disappear (step S302; NO), terminates this coordinates correction information generating process.

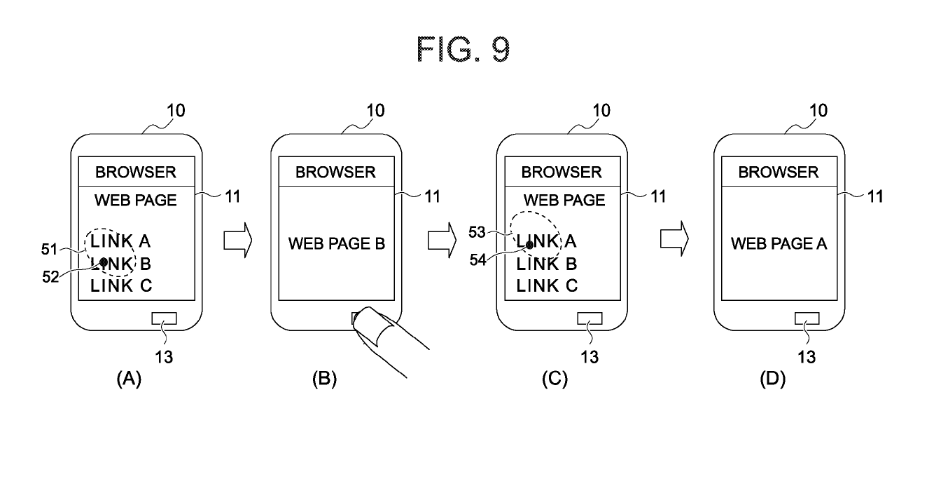

The content of the coordinates correction information generating process will hereinafter be described in a much more specific manner by use of an operation example illustrated in FIG. 9. Note that in the following discussion, a sentence “a certain point is specified as a tap point” implies that “coordinates of a certain point on the touch panel 11 are calculated as the tap coordinates”. In other words, the “tap point” connotes a point on the touch panel 11, of which coordinates are coincident with the calculated tap coordinates.

As depicted in FIG. 9 (A), it is considered that the user taps (single tap) a region 51 in order to display a web page A linked to a link A, and, as a result of this, a point 52 is specified as the tap point.

In this case, a web page B linked to a link B is displayed. Accordingly, the user performs the cancelling operation (pushes the back button 13) within the short time as illustrated in FIG. 9 (B). Moreover, the user redoes the tap operation within the short time. On this occasion, the user taps a region 53 ((C) in FIG. 9) disposed upper than the region 51 tapped first time on the touch panel 11. When the region 53 on the touch panel 11 is tapped, a point 54 is specified as the tap point. Then, as a result thereof, the web page A ((D) in FIG. 9) desired to be browsed by the user is displayed, and hence it follows that the cancelling operation etc. is not conducted for a short while after tapping second time.

Thus, if resulting in the mis-recognition of the tapping destination of the tap operation performed with an intention of tapping a certain object, the user, after conducting the cancelling operation within the short time, redoes the tap operation in the form of intentionally shifting the tapping target region within the short time.

Then, if the tapping destination is mis-recognized, the user, upon getting aware of the tapping destination being mis-recognized, performs the cancelling operation and the tap operation of the second time. Therefore, the cancelling operation is performed normally within 2 sec after the tap operation. Further, the tap operation is conducted second time within, at the longest, 3 sec after the cancelling operation even when carefully performing the tap operation.

Accordingly, if searching the operation history table 33 for the T→C→T records satisfying the conditions 1 and 2 described above (step S301), it is feasible to search for the records related to the three operations carried out in the case where the tapping destination is mis-recognized as illustrated in FIG. 9.

Moreover, the coordinates of the first record are subtracted from the coordinates of the third record (step S303), in which case it is possible to obtain “such a coordinates difference that the coordinates of the third record are calculated as the tap coordinates when performing the tap operation having the same content as the content when recording the first record if added to the coordinates correction value”.

To be specific, such a case is considered that the retrieved T→C→T records are the S→C→S records related to the three operations illustrated in FIG. 9(A). In this case, in step S303, the coordinates difference is calculated such as “the coordinates of the point 54−the coordinates of the point 52”.

Let a detection coordinates Abe a detection coordinates of the tap operation illustrated in FIG. 9(A) and coordinates #1 be the coordinates of the point 52, and the coordinates correction value in the correction information 30 at a point of time when conducting the operation depicted in FIG. 9(A) is expressed such as “coordinates #1−detection coordinates A”. Therefore, the coordinates correction value after the addition of the coordinates difference is given by “(coordinates #1−detection coordinates A)+(coordinates of point 54−coordinates #1)”, i.e., given by “coordinates of point 54−detection coordinates A”. Then, the detection coordinates of the tap operation having the same content as the content illustrated in FIG. 9(A) is the detection coordinates A. Therefore, on the occasion of performing the tap operation, the tap coordinates is calculated such as “detection coordinates A+(coordinates of point 54−detection coordinates A)”, i.e., it follows that the coordinates of the point 54, which is defined as the tap coordinates when conducting the tap operation in FIG. 9(C), is calculated.

Thus, provided that the coordinates of the first record is subtracted from the coordinates of the third record of the T→C→T records, it is possible to calculate “such a coordinates difference that the coordinates of the third record are calculated as the tap coordinates when performing the tap operation having the same content as when recording the first record if added to the coordinates correction value”. As apparent from the calculation procedure, however, this coordinates difference is a value that cannot be added to the coordinates correction value whenever calculated from the T→C→T records. Therefore, the coordinates difference is temporarily stored as an element of the coordinates correction purposed record in the analysis result table 34 (step S305).

Each of the coordinates differences stored in the analysis result table 34 is processed in step S204 of the correction information update process (FIG. 7).

To be specific, in step S204, the CPU 14 executes a process of calculating an average value of the respective coordinates differences stored in the analysis result table 34 and adding the calculated average value to the coordinates correction value in the correction information 30.

Though described in detail later on, the LT threshold correction information generating process executed in step S202 is also a process of temporarily storing the calculated LT threshold correction value as an element of the LT threshold correction purposed record in the analysis result table 34. Further, the DT threshold correction information generating process executed in step S203 is also a process of temporarily storing the calculated DT threshold correction value as an element of the DT threshold correction purposed record in the analysis result table 34.

Hence, step S204 also involves executing a process of calculating the average value of the LT threshold correction values and adding the calculated average value to the LT correction value and a process of calculating the average value of the DT threshold correction values and adding the calculated average value to the DT correction value.

Furthermore, in subsequent step S205, the LT threshold and the DT threshold are recalculated by employing the LT correction value and the DT correction value after adding the average values.

Referring back to FIG. 8, the description of the coordinates correction information generating process is continued.

A reason why the process (determination) in step S304 is provided is that if a shift quantity of the tap coordinates (tap point) in one correction information update process is restricted, it is feasible to give no sense of incongruity to the user when updating the coordinates correction value.

Further, in the operation example illustrated in FIG. 9, the tap operation redone count is “1” so far, however, according to the coordinates correction information generating process, even in the case of redoing the tap operation a plural number of times, the coordinates correction value can be corrected to a value more suited to the user.

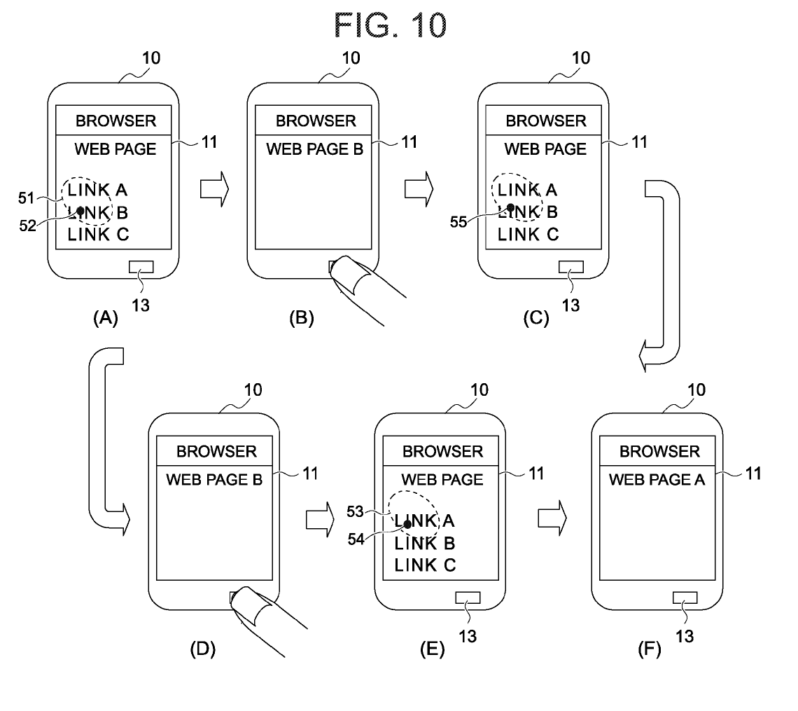

For example, as schematically illustrated in FIG. 10, such a case is considered that the link A is not recognized to be tapped even in the redone tap operation (FIG. 10(C)). In this case, the user, after conducting again the cancelling operation (FIG. 10(D)), taps a region 53 disposed upper than the region tapped second time, thereby obtaining the target web page A (FIG. 10(F)).

In the case of performing a series of operations such as this, the coordinates correction information generating process involves searching for the three records related to the operations in FIGS. 10(A)-10(C) and the three records related to the operations in FIGS. 10(C)-10(E).

Then, the coordinates difference is calculated such as “coordinates of point 55−coordinates of point 52” from the three records related to the operations in FIGS. 10(A)-10(C). Moreover, the coordinates difference is calculated such as “coordinates of point 54−coordinates of point 55” from the three records related to the operations in FIGS. 10(C)-10(E).

Then, an average value thereof, which is given by, i.e., “0.5×(coordinates of point 55−coordinates of point 52+coordinates of point 54−coordinates of point 55)=0.5×(coordinates of point 54−coordinates of point 52)”, are added to the coordinates correction value (FIG. 7; step S204).

When the value given by “0.5×(coordinates of point 54−coordinates of point 52)” are added to the coordinates correction value, the CPU 14 comes to a status of calculating, when the region 51 is tapped, coordinates of a middle point between the point 52 and the point 54 as the tap coordinates.

There might be a case in which the coordinates of this middle point does not imply a determination that the link A is tapped. If the value given by “0.5×(coordinates of point 54−coordinates of point 52)” are added to the coordinates correction value, however, the tap point shifts toward the value given by “coordinates of point 54−coordinates of point 52”. Further, even when the redone count is equal to or larger than “3”, the tap point shifts toward the value given by “coordinates of point 54−coordinates of point 52”. Note that the shift quantity decreases as the redone count increases.

Then, if the tap point shifts toward the value given by “coordinates of point 54−coordinates of point 52”, the tapping destination becomes harder to be mis-recognized even when the shift quantity is small. Accordingly, it follows that the coordinates correction information generating process having the content described above and taking the procedure described above is a process enabling the coordinates correction value to be corrected to the value more suited to the user even when the tap operation is redone a plural number of times.

Next, content of the LT (long tap) threshold correction information generating process will be described.

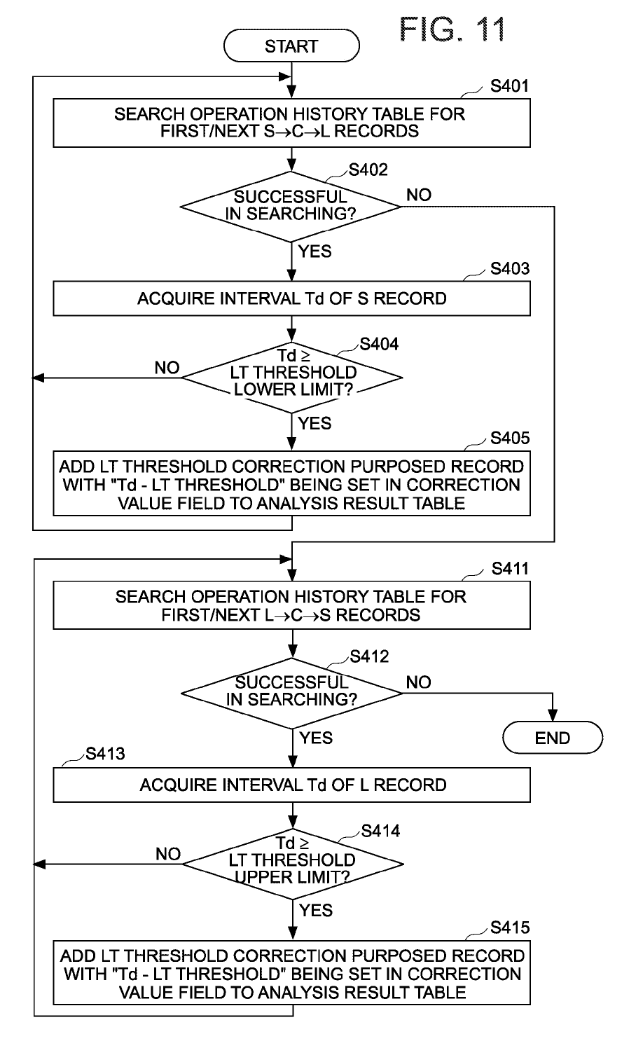

FIG. 11 illustrates a flowchart of the LT threshold correction information generating process. Note that in the following discussion, an LT threshold upper limit, and an LT threshold lower limit connote values that are preset as an upper limit and a lower limit of the LT threshold, respectively.

Processes in steps S401-S405 of this LT threshold correction information generating process are basically processes of repeating a series of following processes till “the three operations performed by the user cannot be specified because the operation conducted with an intention of doing the L operation is mis-recognized as the S operation”, and these processes are:

a process of specifying “the three operations performed by the user because the operation conducted with the intention of doing the L operation is mis-recognized as the S operation” on the basis of the information on the operation history table 33;

a process of calculating a correction value (<0) added to the LT correction value in the correction information 30 on the basis of the contents of the specified three operations; and

a process of adding the LT threshold correction purposed record, in which the calculated correction value is set, to the analysis result table 34.

Moreover, processes insteps S411-S415 of the LT threshold correction information generating process are basically processes of repeating a series of following processes till “the three operations performed by the user cannot be specified because the operation conducted with an intention of doing the S operation is mis-recognized as the L operation”, and these processes are:

a process of specifying “the three operations performed by the user because the operation conducted with the intention of doing the S operation is mis-recognized as the L operation” on the basis of the information on the operation history table 33;

a process of calculating a correction value (<0) added to the LT correction value in the correction information 30 on the basis of the contents of the specified three operations; and

a process of adding the LT threshold correction purposed record, in which the calculated correction value is set, to the analysis result table 34.

Further, the LT threshold correction information generating process is a process of specifying the respective three operations by exploiting such a practice that “if the type of the tap operation is mis-recognized, the user normally redoes the tap operation within the short time after performing the cancelling operation within the short time.

A further specific description thereof will hereinafter be made.

As illustrated in FIG. 11, the CPU 14 having started this LT threshold correction information generating process at first searches the operation history table 33 for the first S→C→L records (step S401).

The S→C→L records searched for in step S401 are three records with the “ID” values being continuous on the operation history table 33 as well as being the three records satisfying the conditions 1 and 2 described above, in which the operations types of the first through third records are “S”, “C” and “L”, respectively. Namely, in step S401, the three records indicating that after the S operation, the C operation is carried out within first specified time (2 sec), and thereafter the L operation is conducted within second specified time (3 sec), are retrieved from the operation history table 33.

If the S→C→L records can be searched for (step S402; YES), the CPU 14 acquires an interval “Td” of the S record in the S→C→L records (step S403). To be more specific, the CPU 14 acquires the interval set in an “INTERVAL” field of the S record and stores the acquired interval notated by “Td”. Note that the value (interval) set in the “INTERVAL” field of the S record represents, as already been described, the tap time.

Subsequently, the CPU 14 determines whether a relation of “Td≧LT threshold lower limit” is established or not (step S404).

If the relation of “Td≧LT threshold lower limit” is not established (step S404; NO), the CPU 14 loops back to step S401 and searches the operation history table 33 for the next S→C→L records.

Whereas if the relation of “Td≧LT threshold lower limit” is established (step S404; YES), the CPU 14 adds the LT threshold correction purposed record with a “Td−LT threshold” being set in the “CORRECTION VALUE” field to the operation history table 33 (step S405). That is, the CPU 14 adds, to the operation history table 33, the LT threshold correction purposed record of which the “Td−LT threshold” for changing the value of the LT threshold to “Td” is set as the correction value (step S405).

The CPU 14 having finished the process in step S405 loops back to step S401 and retrieves the next S→C→L records from the operation history table 33.

The CPU 14 iterates the same processes till the unprocessed S→C→L records disappear. Then, the CPU 14, if the unprocessed S→C→L records disappear (step S402; NO), starts the processes from step S411 onward.

Before explaining contents of the processes from step S411 onward, herein, the contents of the processes in steps S401-S405 are to be described in a further specific manner.

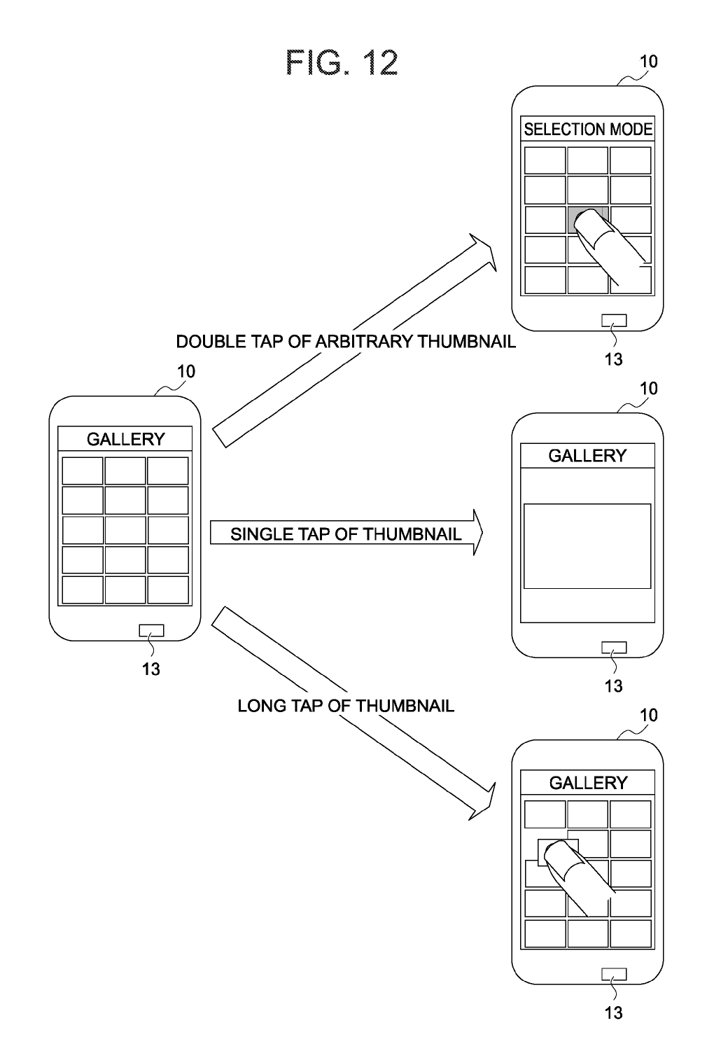

Such a case is considered that the information processing apparatus 10 executes an application for displaying a thumbnail screen of a photo (based on JPEG (Joint Photographic Experts Group) file etc. and displaying, when a thumbnail of a certain photo is tapped, this photo over the full screen. Furthermore, as illustrated in FIG. 12, the application enables, when a certain thumbnail is long-tapped, this thumbnail to be set in a status of its being moved by dragging, and, when an arbitrary thumbnail is double-tapped, the operation is to shift to a selection mode for selecting the photo to be deleted etc.

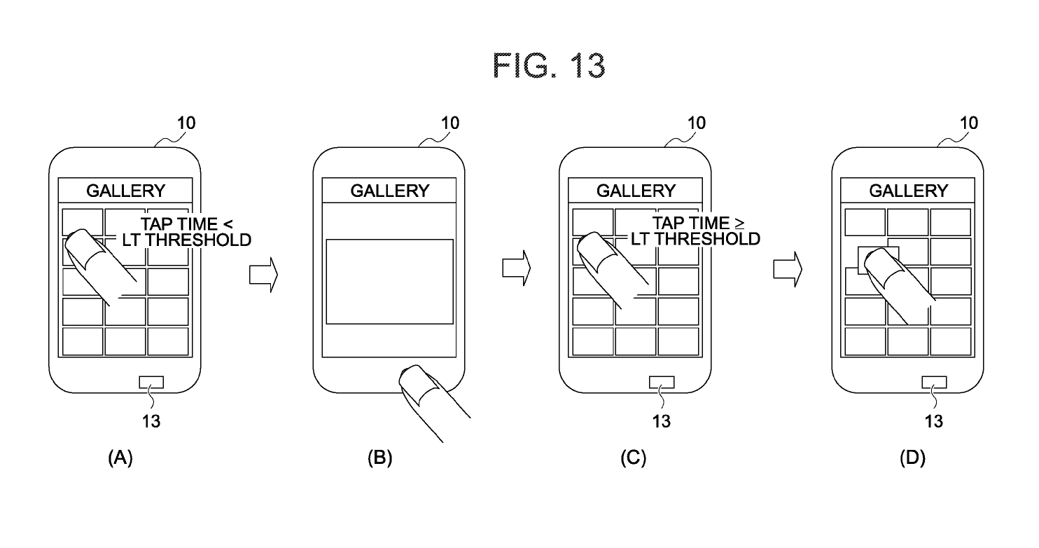

In this case, the user, who wants to move a certain thumbnail, long-taps this thumbnail. As illustrated in FIG. 13(A), however, if the tap time is less than the LT threshold, the CPU 14 (OS 21) determines that the single tap operation is carried out (see FIG. 5). Accordingly, though the photo is displayed on the full screen, this operation is not an operation desired by the user. Therefore, the user, as illustrated in FIGS. 13 (B), 13(C), after performing the cancelling operation within the short time (normally within 2 sec), redoes the long tap operation within the short time (normally within 3 sec). Then, if the tap time of the redone operation is equal to or larger than the LT threshold, as depicted in FIG. 13(D), the thumbnail becomes a drag-enables status, and it follows that the cancelling operation etc. is not conducted for a short while.

In the case of executing a series of such operations, the LT threshold at the present can be determined to be larger than the value suited to the user. Moreover, the LT threshold suited to the user can be also determined to be a value substantially equivalent to the tap time of the tap operation in FIG. 13(A).

Then, the three records on the operation history table 33 with respect to the operations in FIGS. 13(A)-13(C) are the three records arranged in the sequence such as the S record, the C record and the L record, in which an operation time difference between the respective 2 records is small.

Accordingly, if the S→C→L records satisfying the conditions 1 and 2 are retrieved from the operation history table 33 (step S401), it is feasible to search for the three records related to the operations in FIGS. 13(A)-13(C). Further, if the correction value is determined based on the interval “Td” of the S record in the S→C→L records so that the LT threshold becomes the value “Td” (step S405), the tap operation having the tap time substantially equivalent to “Td” can be recognized as the L operation.

Step S404 is a step provided for restraining the LT threshold from becoming excessively small. Step S404, however, also functions as a step of excluding the S→C→L records related to such operations that the first tap operation does not intend the long tap operation, from the LT threshold correction value calculation targets.

Specifically, also if resulting in erroneously performing the single tap operation though the long tap operation should be conducted, the S→C→L records are recorded on the operation history table 33. Further, after a certain object has been single-tapped, also if another object is long-tapped subsequently from promptly conducting the cancelling operation for some reason, the S→C→L records are recorded on the operation history table 33.

Then, if the LT threshold is corrected based on information on such S→C→L records, it follows that improper correction is carried out. The interval of the S record in such S→C→L records is the tap time of the normal single tap operation because the first tap operation does not intend the double tap operation. Hence, it follows from the determination in step S404 that the S→C→L records related to such three operations that the first tap operation does not intend the long tap operation, are excluded from the LT threshold correction value calculation targets.

Moreover, in the operation example illustrated in FIG. 13, the tap operation of the second time is recognized as the long tap operation, however, there is also a case in which the tap operation of the (m+1)-th time (m≧2) is recognized as the long tap operation for the first time.

If the tap operation of the (m+1)-th time is recognized as the long tap operation for the first time, the operation history table 33 is recorded with the records in the sequence such as the S record→ . . . →the S record related to the tap operation of the m-th time→the C record→the L record related to the double tap operation of the (m+1)-th time. Accordingly, in this case, it follows that the three records related to the tap operation of the m-th time, the cancelling operation thereafter and the tap operation of the (m+1)-th time are retrieved as the S→C→L records.

Then, a processing procedure (FIG. 11) of the LT threshold correction information generating process is a procedure in which if the S→C→L records are retrieved, as far as a relation of “Td<LT threshold lower limit” is not established, the LT threshold decreases. Incidentally, it does not normally happen that the tap time of the tap operation being performed with the intention of the long tap operation is less than the LT threshold lower limit.

Hence, according to the processing procedure of the LT threshold correction information generating process, also if the tap operation of the (m+1)-th time (m>2) is recognized as the long tap operation for the first time, the LT threshold can be corrected to the value more suited to the user.

Contents of remaining steps of the LT threshold correction information generating process will hereinafter be described.

The CPU 14 having finished the processes in steps S401-S405 searches the operation history table 33 for the first L→C→S records in step S411.

The L→C→S records searched for in this step S411 are the three records corresponding to the records given by replacing the S record and the L record with each other in the above S→C→L records. Namely, in step S411, the three records indicating that after the L operation, the C operation is carried out within the first specified time (2 sec), and thereafter the S operation is conducted within the second specified time (3 sec), are retrieved from the operation history table 33.

If the L→C→S records can be searched for (step S412; YES), the CPU 14 acquires the interval “Td” of the L record in the L→C→S records (step S413). To be more specific, the CPU 14 acquires the interval (tap time) set in the “INTERVAL” field of the L record and stores the acquired interval notated by “Td”. Then, the CPU 14 determines whether a relation of “Td≦LT threshold upper limit” is established or not (step S414).

If “Td≦LT threshold upper limit” is not established (step S414; NO), the CPU 14 loops back to step S411 and searches the operation history table 33 for the next L→C→S records.

Whereas if “Td≧LT threshold upper limit” is established (step S414; YES), the CPU 14 adds the LT threshold correction purposed record with “Td−LT threshold” being set in the “CORRECTION VALUE” field to the analysis result table 34 (step S415). Then, the CPU 14 loops back to step S411 and retrieves the next L→C→S records from the operation history table 33.

The CPU 14 repeats the same processes till the unprocessed L→C→S records disappear. Then, the CPU 14, when the unprocessed L→C→S records disappear (step S412; NO), finishes this LT threshold correction information generating process.

A further in-depth description of the contents of the processes in steps S411-S415 of the LT threshold correction information generating process will hereinafter be made.

The process in step S411 is a process of searching for, as a tap operation #1 performed with the intention of the S operation is determined to be the L operation, the three records recorded in a case where the user redoes the S operation within the second specified time after conducting the C operation within the first specified time. In other words, the process in step S411 is the process performed for searching for the three records indicating that the LT threshold at the present is smaller than the value suited to the user.

The process in step S411 enables the three records such as this to be actually searched for. Furthermore, if the correction value is determined based on the interval “Td” of the L record in the retrieved L→C→S records so that the LT threshold becomes the value “Td” (step S415), the tap operation with its tap time being substantially equal to the tap time of the tap operation #1 can be recognized as the S operation.

There is, however, a case where the S operation should be performed, and nevertheless the L operation is erroneously conducted. Further, in this case also, the S operation is performed within the short time after conducting the C operation within the short time. Accordingly, the L→C→S records are recorded on the operation history table 33, however, the L→C→S records recorded as a result of making a mistake about the first operation do not indicate that the LT threshold at the present is smaller than the value suited to the user. Therefore, the determination in step S414 is made for enabling the majority of the L→C→S records to be excluded from the correction value calculation targets.

Moreover, there is also a case in which the operation performed with the intention of the S operation continues to be mis-recognized as the L operation but correctly recognized as the S operation for the first time when conducting the tap operation of the (m+1)-th (m≧2). In this case, the operation history table 33 is recorded with the records in the sequence such as the L record→ . . . →the L record related to the tap operation of the m-th time→the C record→the S record related to the tap operation of the (m+1)-th time. Accordingly, the three records related to the tap operation of the m-th time, the cancelling operation thereafter and the tap operation of the (m+1)-th time are retrieved as the L→C→S records.

Then, it is determined whether a relation of “Td≦LT threshold upper limit” is established or not, however, the tap time of the tap operation performed with the intention of the S operation is not larger than the LT threshold upper limit, and hence it is determined that “Td≦LT threshold upper limit” is established, resulting in executing the process in S415.

Thus, the processing procedure enables the LT threshold to be corrected to the value more suited to the user even when recognizing the S operation for the first time when performing the tap operation of the (m+1)-th time (m>2).

Content of the DT threshold correction information generating process (FIG. 7; step S203) will hereinafter be described.

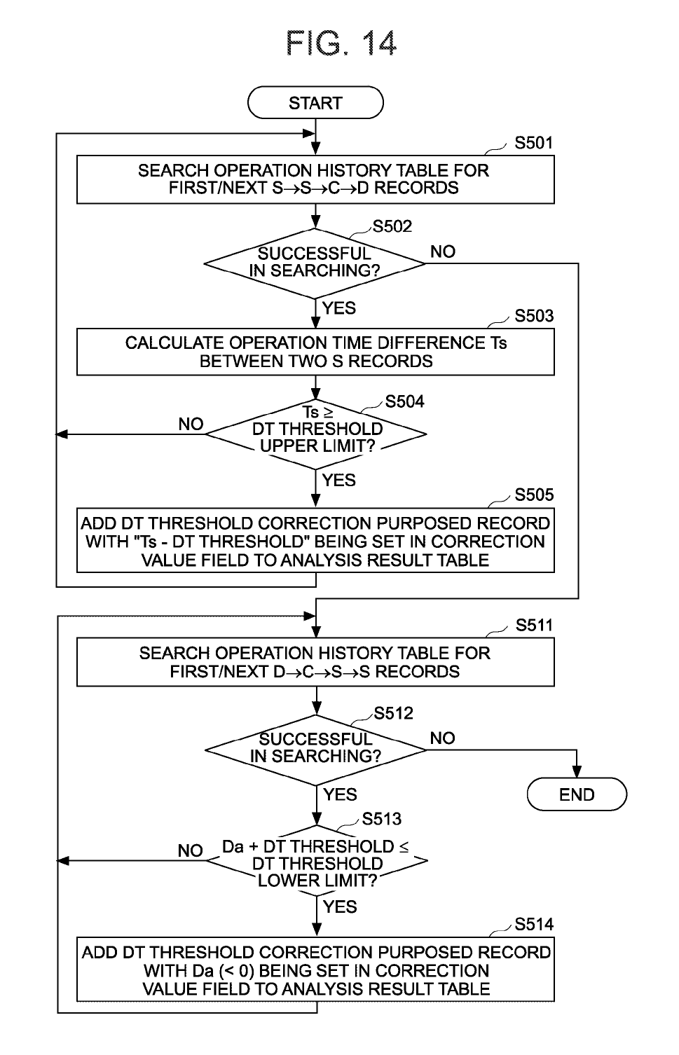

FIG. 14 depicts a flowchart of the DT threshold correction information generating process.

As depicted in FIG. 14, the CPU 14, which has started the DT threshold correction information generating process, at first searches the operation history table 33 for the first S→S→C→D records (step S501).

The S→S→C→D records are basically “four records with the “ID” values being continuous on the operation history table 33, in which the operation types of the first and second records are each the S type, the operation type of the third record is the C type, and the operation type of the fourth record is the D type”. However, the S→S→C→D records satisfy also the following conditions 3-5. Note that in the following discussion, third specified time connotes a preset period of time (1 sec in the first embodiment).

These conditions 3-5 are defined as follows:

### Condition 3: Operation Time of Second Record−Operation Time of First Record≦Third Specified Time;

### Condition 4: Operation Time of Third Record−Operation Time of Second Record≦First Specified Time; and

### Condition 5: Operation Time of Fourth Record−Operation Time of Third Record≦Second Specified Time.

The four records retrieved from the operation history table 33 in the process of step S501 are records related to the following four operations.

When using the application having the S operation-enabled and D operation-enabled objects as illustrated in FIG. 12, there is a case in which the operation performed with the intention of the D operation is recognized as the S operation conducted twice because of the DT threshold being smaller than the value suited to the user. Then, if the operation performed with the intention of the D operation is recognized as the S operation conducted twice, the user redoes the D operation within the short time after performing the C operation within the short time. In the process of step S501, the four records indicating such a series of operations are retrieved from the operation history table 33.

If the S→S→C→D records can be retrieved (step S502; YES), the CPU 14 calculates a difference notated by “Ts” between the operation time and another operation time set in the two S records in the S→S→C→D records (step S503). More concretely, the CPU 14 calculates a tap interval between the two S operations by subtracting the operation time of one S record from the operation time of another S record having a larger “ID” value, and stores the calculated tap interval notated by “Ts”.

Thereafter, the CPU 14 compares the tap interval “Ts” with the DT threshold upper limit defined as information for specifying the preset upper limit of the DT threshold (step S504).

If “Ts≧DT threshold upper limit” is not established (step S504; NO), the CPU 14 loops back to step S501 and searches the operation history table 33 for the next S→S→C→D records.

Further, the CPU 14, if “Ts≧DT threshold upper limit” is established (step S504; YES), adds the DT threshold correction purposed record with “Ts−DT threshold” being set in the “CORRECTION VALUE” field to the analysis result table 34 (step S505).

Then, the CPU 14 loops back to step S501 and searches the operation history table 33 for the next S→S→C→D records.

The CPU 14 repeats the same processes till the unprocessed S→S→C→D records disappear. Then, the CPU 14, when the unprocessed S→S→C→D records disappear (step S502; NO), starts the processes from step S511 onward.

Herein, some items about the processes in steps S501-S505 are to be supplemented, which are considered already apparent, though.

When a certain set of S→S→C→D records are searched for and if the interval of the top S record is “Ts”, the DT threshold is increased to establish “Ts≦DT threshold”, thereby enabling occurrence of a state where the two S operations with the tap interval=Ts are recognized as the D operation. Then, if the DT threshold is increased for a value given by “Ts−DT threshold”, it follows that “Ts=DT threshold” is established. Therefore, it is because “Ts−DT threshold” is set as the correction value in the DT threshold correction purposed record.

If the DT threshold increases excessively, however, the user might feel that a response to the S operation is delayed (refer to steps S105, S107 in FIG. 5). Hence, in step S504, the interval “Ts” is compared with the DT threshold upper limit, and, if “Ts” is larger than the DT threshold upper limit, it is contrived that the process in step S505 is not executed.

Contents of the processes from step S511 onward in the DT threshold correction information generating process will hereinafter be described.

The CPU 14 having finished the processes in steps S501-S505 searches the operation history table 33 for first D→C→S→S records in step S511.

The D→C→S→S records are basically “four records with the “ID” values being continuous on the operation history table 33, in which the operation type of the first record is the D type, the operation type of the second record is the C type, and the operation types of the third and fourth records are each the S type”. However, the D→C→S→S records satisfy also the following conditions 6-8.

These conditions 6-8 are defined as follows:

Condition 6: Operation Time of Second Record−Operation Time of First Record≦First Specified Time (=2 sec);
Condition 7: Operation Time of Third Record−Operation Time of Second Record≦Second Specified Time (=3 sec); and
Condition 8: Operation Time of Fourth Record−Operation Time of Third Record≦Third Specified Time (1 sec).

As obvious from the record sequence such as D, C, S, S and the conditions 6-8, step S511 involves searching for the four records related to “the operation of redoing the S operation twice after performing the C operation because the operation conducted with the intention of the two S operations is recognized as the D operation”.

The D→C→S→S records can be searched for (step S512; YES), in which case the CPU 14 determines whether a relation of “Da+DT threshold DT threshold lower limit” is established or not (step S513). Herein, the symbol “Da” represents a negative value that is preset as decrement time (e.g., −5 ms) of the DT threshold (DT threshold correction value) based on one correction information update process.

If “Da+DT threshold≦DT threshold lower limit” is not established (step S513; NO), the CPU 14 loops back to step S511 and searches the operation history table 33 for the next D→C→S→S records.

Whereas if “Da+DT threshold≦DT threshold lower limit” is established (step S513; YES), the CPU 14 adds, to the operation history table 33, the DT threshold correction purposed record with “Da” being set in the “CORRECTION VALUE” field (step S514). To be specific, the CPU 14 adds, to the operation history table 33, the DT threshold correction purposed record with the decrement time “Da”, for decrementing the DT threshold by a fixed quantity, being set as the correction value.

Note that the process in step S514 can be changed to a process of adding, to the operation history table 33, the DT threshold correction purposed record with “D record interval−DT threshold” being set in the “CORRECTION VALUE” field by eliminating the determination in step S513. Further, the process in step S514 can be also changed to a process of adding, to the operation history table 33, the DT threshold correction purposed record with “D record interval−DT threshold” being set in the “CORRECTION VALUE” field by changing the determination in step S513 to another determination.

The CPU 14 having finished the process in step S514 loops back to step S511.

The CPU 14 repeats the same processes till the unprocessed D→C→S→S records disappear. Then, the CPU 14, when the unprocessed D→C→S→S records disappear (step S51; NO), terminates this DT threshold correction information generating process.

The CPU 14, which has finished the DT threshold correction information generating process (FIG. 7; step S203), as already described, calculates an average value of the correction values on the analysis result table 34 on a per correction target identifier basis, and adds the average value to the corresponding correction value in the correction information 30 (step S204). Subsequently, the CPU 14 recalculates the LT threshold and the DT threshold (step S205).

Thereafter, the CPU 14 clears the operation history table 33 and the analysis result table 34 (step S206). Then, the CPU 14 finishes the correction information update process and comes to a status of monitoring if the record count on the operation history table 33 becomes equal to or larger than a predetermined count and so on while executing the operation distinguishing process.

### Second Embodiment

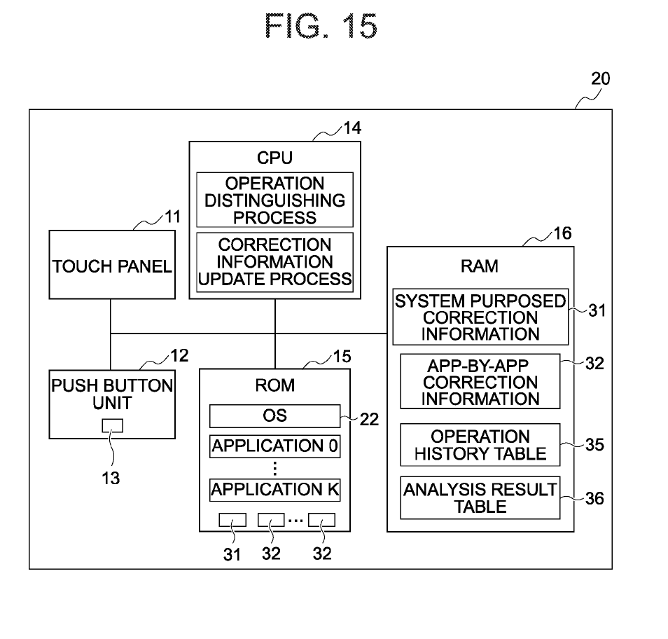

FIG. 15 illustrates a schematic configuration of an information processing apparatus 20 according to a second embodiment.

The information processing apparatus 20 according to the second embodiment is an apparatus configured to change the OS 21 of the information processing apparatus 10 according to the first embodiment to an OS 22. Then, the respective processes executed by the CPU 14 according to the OS 22 have portions common to the processes executed by the CPU 14 according to the OS 21. Therefore, the following discussion will touch, while focusing on different potions from the information processing apparatus 10 according to the first embodiment, a configuration and an operation of the information processing apparatus 20 according to the second embodiment.

To begin with, in the following description, some terminologies newly used are defined.

In the following description, the first tap operation with the tapping destination/type being mis-recognized is referred to as a “first operation”. Further, a tap operation enabling the information processing apparatus 20 (application) to execute a target operation by redoing the operation several times after the first operation, is referred to as a final operation. Moreover, a series of operations starting with the first operation and ending with the final operation are termed a special operation sequence. In short, the operations as in FIG. 9(A) and FIG. 10(A) are referred to as the first operations, while the operations as in FIG. 9(C) and FIG. 10(E) are referred to as the final operations. Furthermore, the operation sequences as in FIGS. 9(A)-9(C) and FIGS. 10(A)-10(E) are termed the special operation sequences.

Referring back to FIG. 15, the configuration and the operation of the information processing apparatus 20 will be described.

As depicted in FIG. 15, the information processing apparatus 20 operates in a status where the RAM 16 is stored with system purposed correction information 31, some pieces (one piece in FIG. 15) of application-by-application correction information 32, an operation history table 35 and an analysis result table 36. Further, the CPU 14 of the information processing apparatus 20 executes the operation distinguishing process and the correction information update process.

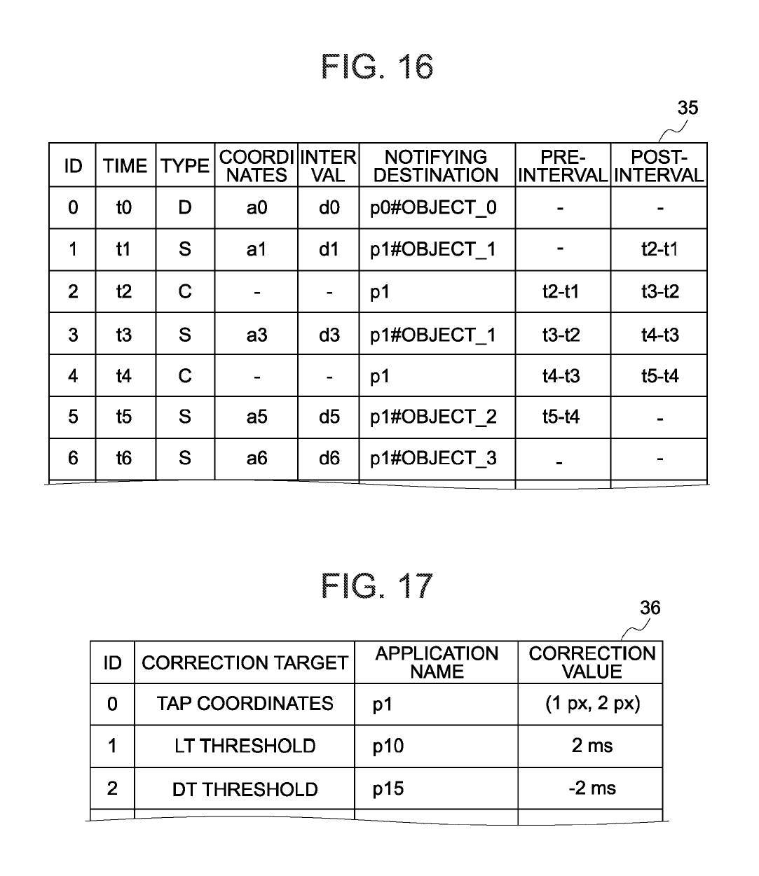

FIGS. 16 through 19 illustrate structures (data structures) of the operation history table 35, the analysis result table 36, the system purposed correction information 31 and the application-by-application correction information 32, respectively.

As illustrated in FIG. 16, the operation history table 35 has a structure of adding a “PRE-INTERVAL” field and a “POST-INTERVAL” field to the operation history table 33 (FIG. 6) of the information processing apparatus 10.

The fields other than the “PRE-INTERVAL” field and the “POST-INTERVAL” field of the operation history table 35 are the same fields registered with the settings of the same items of information as those of the operation history table 33.

The “PRE-INTERVAL” field and the “POST-INTERVAL” field are fields registered with settings of “self-record operation time previous record operation time” (which will hereinafter be termed the pre-interval) and “next record operation time−self-record operation time” (which will hereinafter be termed the post-interval), respectively. However, the pre-interval and the post-interval are set only in the “PRE-INTERVAL” field and the “POST-INTERVAL” field of a record related to the operation having a possibility of being a component of the special operation sequence. A procedure of setting the pre-interval and the post-interval in the “PRE-INTERVAL” field and the “POST-INTERVAL” field and uses of the pre-interval and the post-interval that are set in the “PRE-INTERVAL” field and the “POST-INTERVAL” field, will be discussed later on.

As depicted in FIG. 17, the analysis result table 36 is a table having a structure of adding an “APPLICATION NAME” field to the analysis result table 34 (FIG. 4).

The “ID” field, the “CORRECTION TARGET” field and the “CORRECTION VALUE” field of this analysis result table 36 are fields registered with settings of the same items of information as those set respectively in the “ID” field, the “CORRECTION TARGET” field and the “CORRECTION VALUE” field of this analysis result table 34. The “APPLICATION NAME” field of the analysis result table 36 is a field registered with a setting of an operation target application name (the application name set in the “NOTIFYING DESTINATION” field) of the record of the operation history table 35, the application being used for calculating the correction value set in the “CORRECTION VALUE” field.

In the analysis result table 36, the records containing “tap coordinates”, “DT threshold” and “LT threshold” set in the “CORRECTION TARGET” field are referred to as the coordinates correction purposed record, the DT threshold correction purposed record and the LT threshold correction purposed record, respectively.

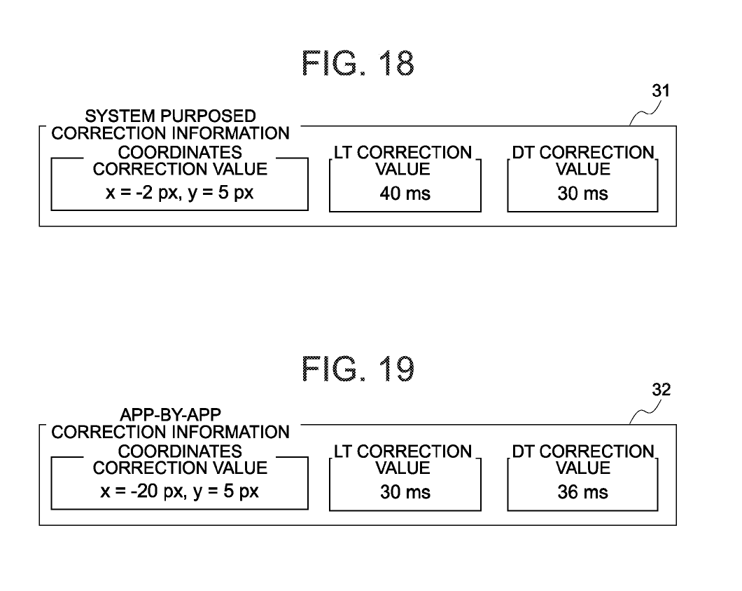

As illustrated in FIG. 18, the system purposed correction information 31 is information having the same structure as the correction information 30 (FIG. 3) has.

This system purposed correction information 31 is, similarly to the correction information 30, the information loaded onto the RAM 16 from the ROM 15 when starting up the information processing apparatus 20 and written back to the ROM 15 when shutting down etc. the information processing apparatus 20. Moreover, the system purposed correction information 31 is also the information that is updated in the same procedure as the update procedure of the correction information 30.

The correction information update process (which will hereinafter be referred to also as a second correction information update process) according to the second embodiment is, however, a process of not calculating the correction value (the details thereof will be described later on) on the basis of an element sequence (three operations etc. in FIGS. 10(A)-10(C)) of the special operation sequence. Further, the second correction information update process is also a process of adding a value given by further halving (½) an average value of the correction values for the tap coordinates/LT threshold/DT threshold which are calculated based on content of the special operation sequence, to each of the correction values in the system purposed correction information 31. Accordingly, the value itself of each correction value in the system purposed correction information 31 is different, though having the same operation history of the user, from the value of each correction value in the correction information 30.

As illustrated in FIG. 19, the application-by-application correction information 32 is information having the same structure as that of the system purposed correction information 31 (FIG. 18). This application-by-application correction information 32 is such a type of formation that when executing a certain application first time, a copy of the system purposed correction information 31 at this point of time is prepared for this application on the RAM 16. Further, the application-by-application correction information 32 for each application is the formation updated in the same procedure with the same algorithm as those for the system purposed correction information 31 except that the record of the analysis result table 36 used for updating is the record registered with the setting of the application name of each application. Note that when terminating a certain application, the CPU 14 (OS 22) saves, on the ROM 15, the application-by-application correction information 32 for this application on the RAM 16.

Next, content of the operation distinguishing process according to the second embodiment will be described.

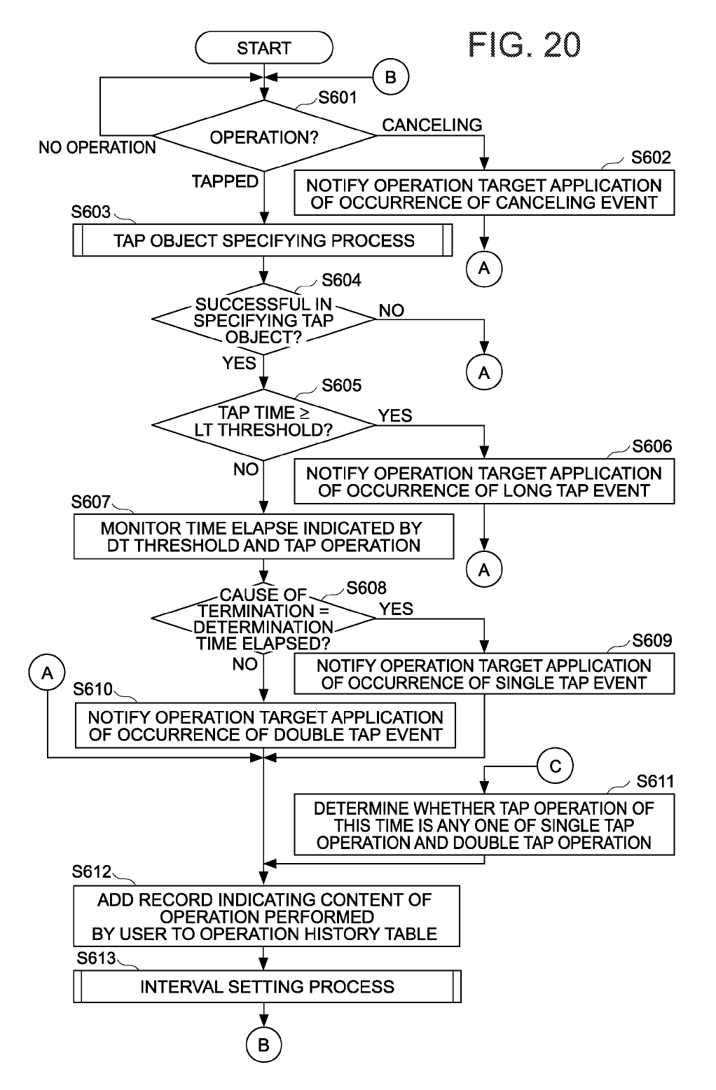

FIG. 20 illustrates a flowchart of the operation distinguishing process (which will hereinafter be termed also the second operation distinguishing process) according to the second embodiment.

Processes in steps S601, S602, S604 S611 of this second operation distinguishing process are the same as those in respective steps S101, S102, S104 S111 of the operation distinguishing process (FIG. 5; which will hereinafter be termed also the first operation distinguishing process) according to the first embodiment. Hence, in the following description, the content of this second operation distinguishing process will be discussed in a way that focuses on contents of the processes in steps S603, S612 and S613.

Note that in the following description, a system purposed coordinates correction value, a system purposed LT threshold and a system purposed DT threshold represent the coordinates correction value, the LT threshold and the DT threshold in the system purposed correction information 31 (FIG. 18), respectively. Operation target application purposed correction information connotes the application-by-application correction information 32 (FIG. 19) for the operation target application. An operation target application purposed coordinates correction value, an operation target application purposed LT threshold, an operation target application purposed DT threshold represent the coordinates correction value, the LT threshold and the DT threshold in the operation target application purposed correction information, respectively.

AS depicted in FIG. 20, the CPU 14 (OS 22) executing the second operation distinguishing process underway performs, when the tap operation is conducted (step S601; tapped), a tap object specifying process (step S603).

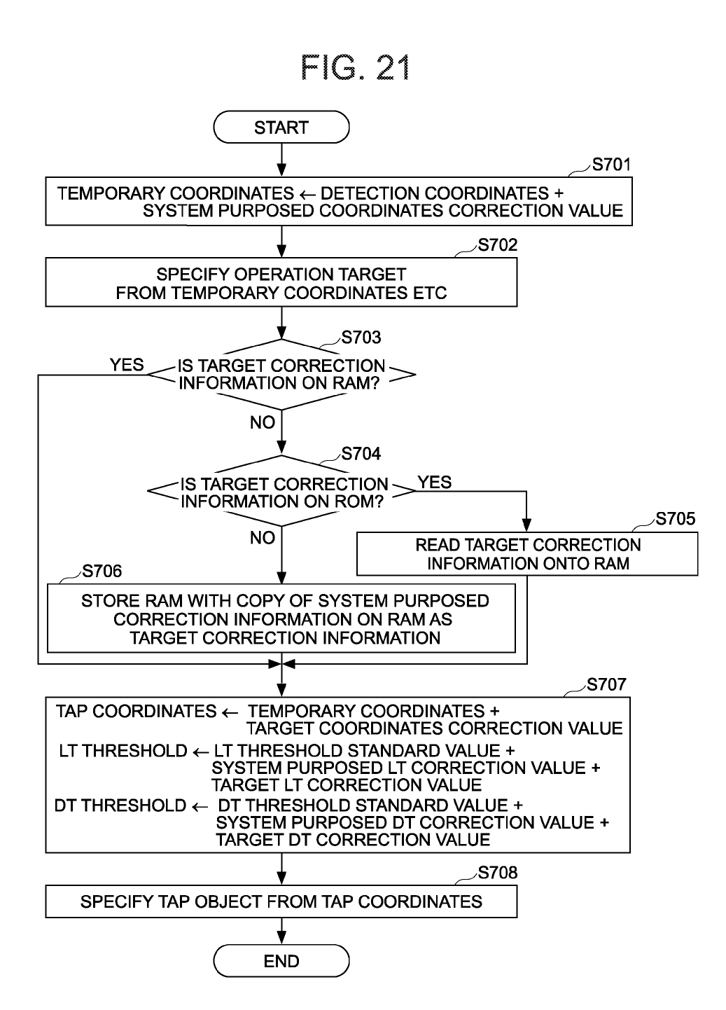

This tap object specifying process is a process taking a procedure illustrated in FIG. 21.

Namely, the CPU 14 (OS 22), which has started the tap object specifying process, at first calculates a temporary coordinates by adding a system purposed coordinates correction value (the coordinates correction value in the system purposed correction information 31) on the RAM 16 to the detected coordinates (step S701).

Subsequently, the CPU 14 specifies an application becoming the tap operation target of this time (which will hereinafter be referred to as an operation target application) on the basis of the thus-calculated temporary coordinates and items of information on a shape etc. of each the objects displayed by the individual applications in the execution underway (step S702).

The CPU 14 having finished specifying the operation target application determines whether or not the operation target application purposed correction information (the application-by-application correction information 32 for the operation target application) exists on the RAM 16 (step S703). Then, the CPU 14, if the operation target application purposed correction information exists on the RAM 16 (step S703; YES), starts processes from step S707 onward.

Whereas if the operation target application purposed correction information does not exist on the RAM 16 (step S703; NO), the CPU 14 determines whether the operation target application purposed correction information exists on the rom 15 or not (step S704). If the operation target application purposed correction information exists on the ROM 15 (step S704; YES), the CPU 14 reads the operation target application purposed correction information onto the RAM 16 and thereafter starts the processes from step S707 onward.

Furthermore, the CPU 14, if the operation target application purposed correction information does not exist on the ROM 15 (step S704; NO), stores the RAM 16 with the copy of the system purposed correction information 31 on the RAM 16 by way of the operation target application purposed correction information 32 (step S706). Then, the CPU 14 starts the processes from step S707 onward.

In step S707, the CPU 14 adds the operation target application purposed coordinates correction value to the temporary coordinates, thereby calculating the tap coordinates. Further, the CPU 14 adds the system purposed LT correction value and the operation target application purposed LT correction value to the LT threshold standard value, thereby calculating the LT threshold. Still further, the CPU 14 adds the system purposed DT correction value and the operation target application purposed DT correction value to the DT threshold standard value, thereby calculating the DT threshold.

It is to be noted that the CPU 14, if the calculated tap coordinates is coordinates of a point on the object displayed by the application other than the operation target application, changes the tap coordinates so as to become the coordinates of the point on the object displayed by the operation target application. To be specific, the CPU 14 obtains a maximum value “kmax” of such a value “k” that a value given by “temporary coordinates+k′ operation target application purposed coordinates correction value” becomes the coordinates of the point on the object displayed by the operation target application, and changes the tap coordinates to a value given by “temporary coordinates+kmax×operation target application purposed coordinates correction value”.

The CPU 14 having finished the process in step S707 specifies the tap object on the basis of the calculated tap coordinates (step S708). Note that the process in this step S708 is, similarly to the process in step S103, the process including the case of not specifying the tap object.

Then, the CPU 14 having finished the process in step S708 terminates this tap object specifying process (the process in FIG. 21).

In short, this tap object specifying process is, similarly to the process in step S103, the process of calculating the tap coordinates and specifying the tap object on the basis of the calculated tap coordinates. In the tap object specifying process, however, the tap coordinates are calculated by exploiting the system purposed correction information 31 and the application-by-application correction information 32. Moreover, in the tap object specifying process, the LT threshold and the DT threshold for determining the type of the tap operation are calculated by exploiting the system purposed correction information 31 and the application-by-application correction information 32.

Referring back to FIG. 20, the description of the second operation distinguishing process is continued.

After the tap object specifying process, the CPU 14 (OS 22), which has notified the operation target application of occurrence of a certain event (single tap event etc.), adds a record indicating content of the operation performed by the user to the operation history table 35 (step S612). The record added to the operation history table 35 when in the process of step S612 is the same as the record added to the operation history table 33 when in the process of step S112 (FIG. 5) except that “NULL” is set in the “PRE-INTERVAL” field and the “POST-INTERVAL” field.

Thereafter, the CPU 14 executes an interval setting process (step S613).

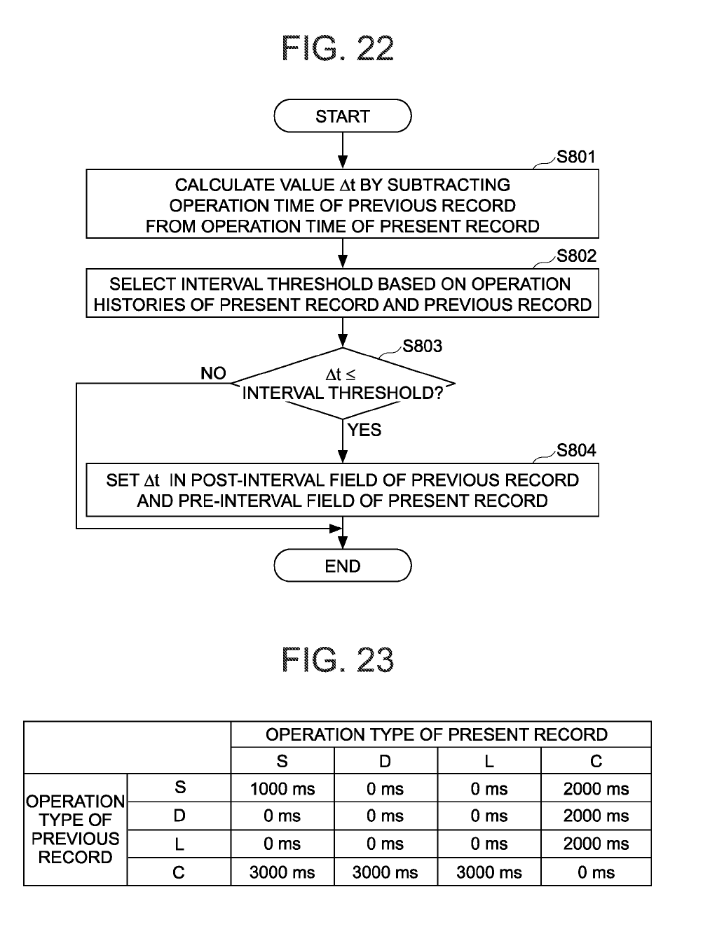

FIG. 22 illustrates a flowchart of the interval setting process. This interval setting process is, as far as the present record and the previous record are the records related to the operation having the possibility of being the component of the special operation sequence, a process of setting the pre-interval and the post-interval in the “POST-INTERVAL” field of the previous record and the “PRE-INTERVAL” field of the present record, respectively. Note that the present record connotes a record added this time to the operation history table 35, and the previous record connotes a record added last time to the operation history table 35.

As illustrated in FIG. 22, the CPU 14 (OS 22), which has started the interval setting process, calculates, to begin with, a value Δt by subtracting the operation time of the previous record from the operation time of the present record (step S801).

Subsequently, the CPU 14 selects an interval threshold used in the process of step S803 from the operation type of the present record and the operation type of the previous record (step S802).

FIG. 23 depicts an associative relation between the interval threshold selected in the process of step S802 and a combination of the operation types. As apparent from FIG. 23, the CPU 14 selects 2000 ms (2 sec) as the interval threshold in a case where the operation type of the previous record is the S type (single tap) or the D type (double tap) or the L type (long tap), while the operation type of the present record is the C type (cancel).

The CPU 14 selects 3000 ms as the interval threshold in a case where the operation type of the previous record is the C type, while the operation type of the present record is the S type or the L type or the D type. Further, the CPU 14 selects 1000 ms as the interval threshold in a case where both of the operation type of the previous record and the operation type of the present record are the S types and selects 0 ms as the interval threshold in a case where a combination of the operation types of the previous and present records is a different combination.

Note that the interval thresholds such as 2000 ms, 3000 ms and 1000 ms are pieces of information which correspond respectively to the first specified time, the second specified time and the third specified time in the first embodiment.

The CPU 14 having finished the process in step S802 (FIG. 22) determines whether a relation of “Δt≦interval threshold” is established or not (step S803). If “Δt≦interval threshold” is established (step S803; YES), the CPU 14 sets “Δt” in the “POST-INTERVAL” field of the previous record and in the “PRE-INTERVAL” field of the present record (step S804). Then, the CPU 14 finishes this interval setting process.

Whereas if “Δt≦interval threshold” is not established (step S803; NO), the CPU 14 terminates the interval setting process without executing the process in step S804.

In short, as obvious from the contents of the three types of correction information generating processes according to the first embodiment, the operations each having the possibility of being the component of the special operation sequence are given as follows.

These operations are:

(1) the T (S, L or D) operation conducted within 3 sec after completing the C operation;
(2) the C operation with the T operation being performed within 3 sec after the completion thereof;
(3) the C operation done within 2 sec after completing the T operation;
(4) the T operation with the C operation being performed within 2 sec after the completion thereof;
(5) the S operation conducted within 1 sec after completing the S operation; and
(6) the S operation with the S operation being conducted within 1 sec after the completion thereof.

In step S802 of the interval threshold, numbers of seconds (3, 2, 1) in the explanatory note (1), (3) or (5) are selected as the interval thresholds from the combination of the operation types of the present record and the previous record. Further, the determination (step S803) as to whether “Δt≦interval threshold” is established involves making a determination as to any one of whether “Δt≦3” is established, whether “Δt≦2” is established and whether “Δt≦1” is established in accordance with the combination of the operation types of the present record and the previous record. Then, the operation of the present record has the possibility of being the component of the special operation sequence, in which case the operation of the previous record has also the possibility of being the component of the special operation sequence (refer to (1) and (2), (3) and (4), (5) and (6)). Therefore, the value Δt is set simultaneously in the “POST-INTERVAL” field of the previous record and in the “PRE-INTERVAL” field of the present record (step S804).

Content of the second correction information update process (the correction information update process executed by the CPU 14 (OS 22)) will hereinafter be described.

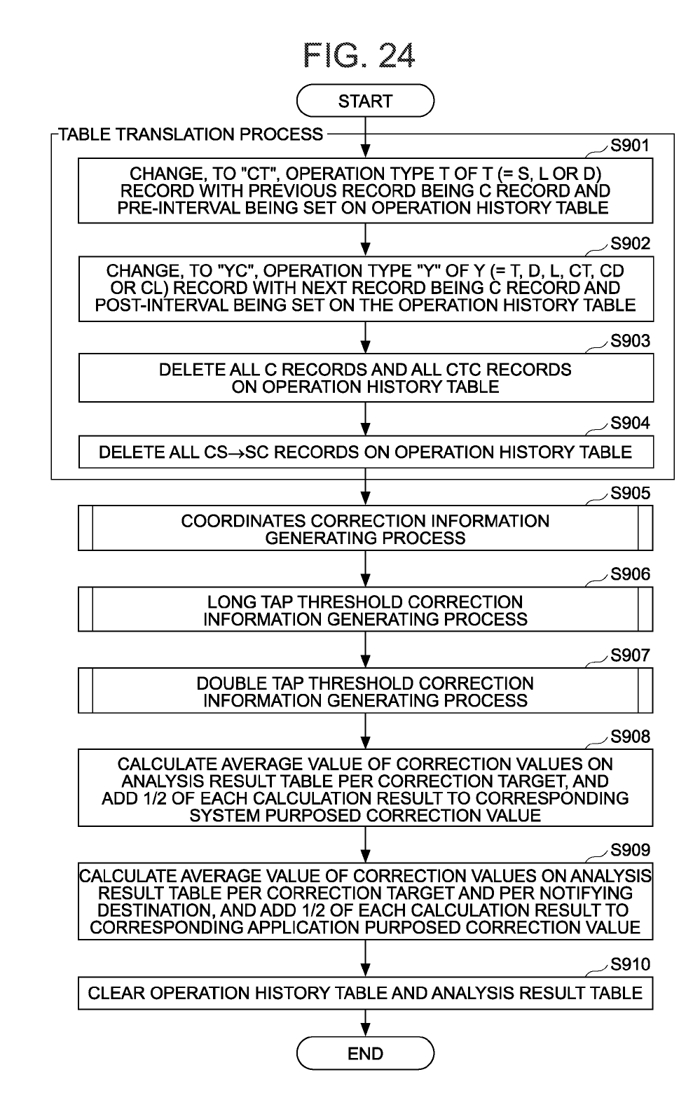

FIG. 24 illustrates a flowchart of the second correction information update process.

To begin with, content of a table translation process (processes in steps S901-S904) will be explained.

Note that in the following discussion, expressions such as “the pre-interval is set” and “the post-interval is set” have a meaning that “the value in the “PRE-INTERVAL” field is not “NULL” and a meaning that “the value in the “POST-INTERVAL” field is not “NULL”, respectively. An X (=S, CS, etc.) record connotes a record of which the operation type is “X” on the operation history table 35. Moreover, “T” implies S, L or D. Accordingly, “CT” implies CS, CL or CD. This CT may be a character string “CT” and may also be information indicating “CT”.

The table translation process is a process of translating (processing) the operation history table 35 into a “table in which the information on the first operation and the final operation of the special operation sequence is acquired by searching for the two continuous records without depending on the redoing count of the tap operation”.

As illustrated in FIG. 24, the CPU 14, which has started the table translation process, at first changes, to “CT”, the operation type of each T record with the previous record being the C record and the pre-interval being set on the operation history table 35 (step S901). Subsequently, the CPU 14 changes, to “YC”, the operation type “Y” (=S, D, L, CS, CD or CL) of each Y record with the next record being the C record and the post-interval being set on the operation history table 35 (step S902). Note that the interval setting process (FIG. 22) described above is executed mainly so that the operation time difference between the two records may not be calculated when in the processes of these steps.

Thereafter, the CPU 14 deletes the respective C records on the operation history table 35 (step S903). Further, the CPU 14 deletes the respective CTC records on the operation history table 35 (step S903). Still further, the CPU 14 deletes the respective CS R SC records on the operation history table 35 (step S903). Herein, the CS R SC records are two records arranged in the sequence such as the CS record and the SC record (the sequence is that the CS record is previous to the SC record, and this same sequence is applied hereinafter).

The content of the table translation process (the processes in steps S901 S904) will hereinafter be specifically described by exemplifying a case that the user performs the special operation sequence of which the content is illustrated in FIG. 9 and a case that the user conducts the special operation sequence of which the content is illustrated in FIG. 10.

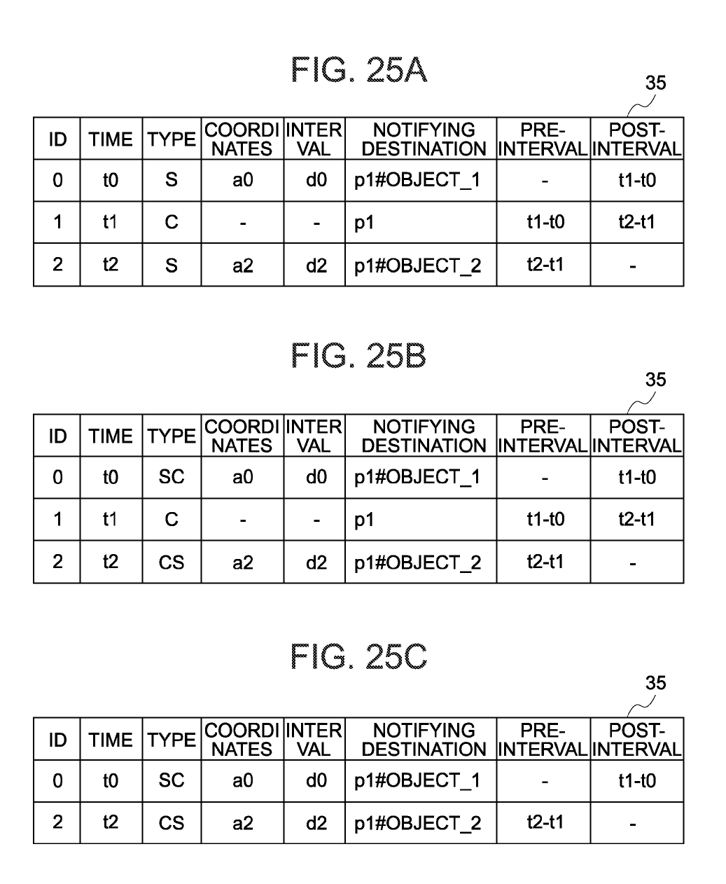

In a status where none of the records are stored in the operation history table 35, if the user performs the special operation sequence of which the content is illustrated in FIG. 9, the S record indicating the operation in FIG. 9(A) is added to the operation history table 35. Thereafter, the C record indicating the operation in FIG. 9(B) and the S record indicating the operation in FIG. 9 (C) are sequentially added to the operation history table 35. Moreover, the interval setting process is executed each time the record is added, and hence the contents of the operation history table 35 are turned into contents illustrated in FIG. 25A.

Further, if the user carries out the special operation sequence of which the contents are illustrated in FIG. 10, the S record indicating the operation in FIG. 10(A), the C record indicating the operation in FIG. 10(B) and the S record indicating the operation in FIG. 10(C) are sequentially added to the operation history table 35. Moreover, the C record indicating the operation in FIG. 10(D), and the S record indicating the operation in FIG. 10(E) are also added to the operation history table 35. Then, the interval setting process is executed each time the record is added, and therefore, if one record is stored in the operation history table 35 before starting the special operation sequence, the contents of the operation history table 35 are turned into contents depicted in FIG. 16.

Then, if the contents of the operation history table 35 given when starting the table translation process are those illustrated in FIG. 25A, the contents of the operation history table 35 are changed into contents depicted in FIG. 25B through the processes in step S901 and S902.

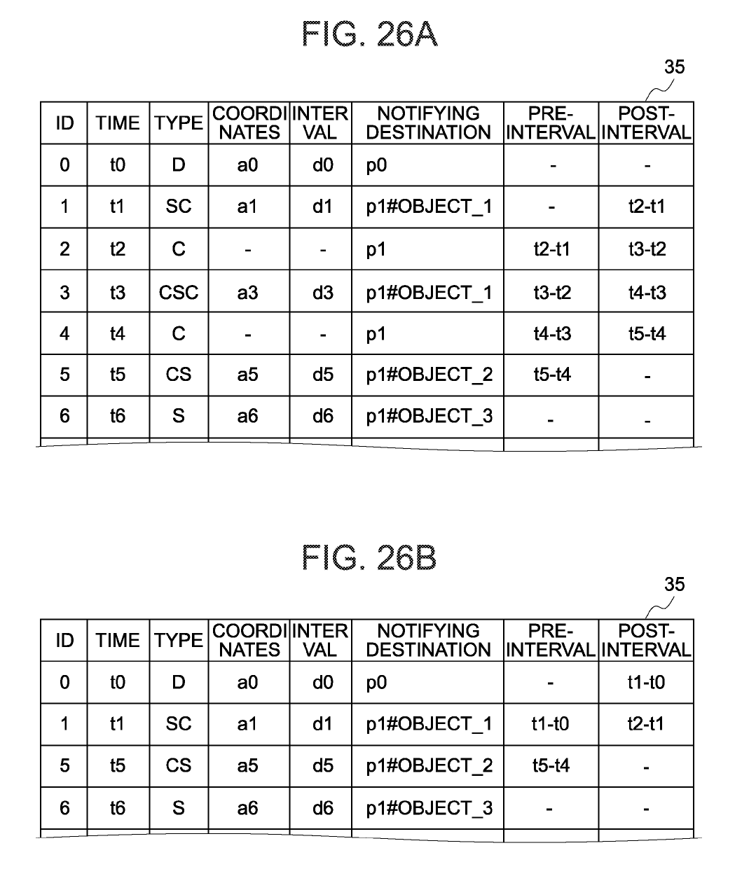

Moreover, if the operation history table 35 having the contents illustrated in FIG. 16 undergoes the processes in step S901 and S902 of the table translation process, it follows that the contents of the operation history table 35 are changed into contents depicted in FIG. 26A.

As apparent from FIGS. 25B and 26A, through the processes in steps S901 and S902, the operation history table 35 becomes the table enabling the determination to be made from only the operation types as to whether or not each tap operation is the operation having the possibility of being the component of the special operation sequence. Accordingly, the contents of the special operation sequence can be grasped even by deleting the respective C records on the operation history table 35.

Furthermore, “CTC” (CSC, CLC, CDC; CSC in FIG. 26A) records are the records related to the tap operation with the C operation being conducted immediately before and after this operation, i.e., the tap operation that is neither the first operation nor the final operation. Accordingly, even when deleting the respective CSC records on the operation history table 35, the records related to the first operation and the final operation of the special operation sequence remain on the operation history table 35.

Then, if the respective CTC records and the respective C records on the operation history table 35 are deleted, as depicted in FIGS. 25C and 26B, it is possible to form a state where the two records pertaining to the first operation and the final operation of the special operation sequence are arranged. Note that the operation history table 35 illustrated in FIGS. 25C and 26B has such contents that the CTC records and the C records are eliminated from the operation history table 35 depicted in FIGS. 25B and 26A.

Therefore, it is because the processes having the contents described above are executed in steps S901-S903.

Contents of the two single tap operations (which will hereinafter be abbreviated to the SS operation) not recognized as the D operations are, however, recorded as the two records on the operation history table 35. Then, through the processes in steps S901 and S902, the two records related to the SS operation not being the first operation become the CS→SC records. Hence, a contrivance is that with respect to the special operation sequence also to which the SS operation is related, it is feasible to form the state where the record representing the content of the first SS operation and the record related to the final operation (D operation) are arranged.

It is to be noted that the record representing the content of the first SS operation indicates “the SC record in which the pre-interval is set, with the next record being the CD record concerning the final operation (D operation)”.

Concretely, the two S records are added to the operation history table 35 when in the SS operation. Then, through the interval setting process, the pre-interval (“operation time of self-record operation time of previous record”), i.e., the tap interval of the SS operation, is set in the “PRE-INTERVAL” field of the S record related to the second S operation. Subsequently, when starting the correction information update process, through the process in step S902, the operation type of the S record is changed to the SC type, however, the pre-interval is not set in the SC record related to the S operation not being the second S operation of the SS operation (see FIGS. 23, 26A, etc.). Therefore, it follows that “the SC record with the pre-interval being set therein”, which exists on the operation history table 35 after completing the process in step S902 (FIG. 24), is the record indicating that the SS operation having the tap interval coincident with the pre-interval set therein is carried out. Then, when the CS→SC records are deleted, only the SC records pertaining to the first SS operation are left on the operation history table 35. Accordingly, it follows that “the SC record in which the pre-interval is set, with the next record being the CD”, which exists on the operation history table 35 after the table translation process, is “the record representing the content of the first SS operation”.

The CPU 14 (OS 22), which has completed the table translation process (FIG. 24), executes the coordinates correction information generating process (step S905), the LT threshold correction information generating process (step S906) and the DT threshold correction information generating process (step S907).

Contents of the respective correction information generating process will hereinafter be described. Note that for the sake of the explanation, in the following discussion, the coordinates correction information generating process, the LT threshold correction information generating process and the DT threshold correction information generating process according to the second embodiment are termed a second coordinates correction information generating process, a second LT threshold correction information generating process and a second DT threshold correction information generating process, respectively. Moreover, the coordinates correction information generating process, the LT threshold correction information generating process and the DT threshold correction information generating process according to the first embodiment are termed a first coordinates correction information generating process, a first LT threshold correction information generating process and a first DT threshold correction information generating process, respectively.

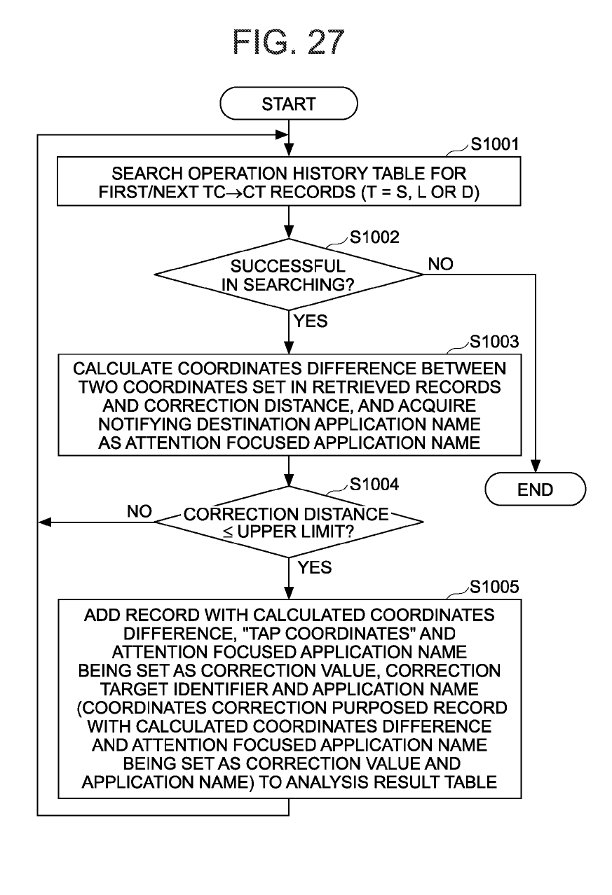

FIG. 27 depicts a flowchart of the second coordinates correction information generating process.

As depicted in FIG. 27, the CPU 14, which has started the second coordinates correction information generating process, searches at first the operation history table 35 for the first TC→CT records (SC→CS records, LC→CL records or DC→CD records) (step S1001). The TC→CT records searched for in step S1001 are the two records arranged in the sequence of the TC record and the CT record on the operation history table 35.

Namely, the operation history table 35 are, through the interval setting process and the table translation process, transformed and processed into a table having the contents illustrated in FIGS. 25C and 26B. Therefore, owing to the search for the TC→CT records, the two records related to the first operation and the final operation of the special operation sequence that are conducted due to the mis-recognition of the tapping destination, can be retrieved from the operation history table 35 regardless of the redoing count in the special operation sequence.

If the TC→CT records can be retrieved (step S1002; YES), the CPU 14 acquires coordinates of the TC record and coordinates of the CT record of the TC→CT records (step S1003). Then, the CPU 14 calculates a coordinates difference by subtracting the coordinates of the CT record from the coordinates of the TC record, and also calculates a correction distance defined as a distance between the points indicated by the two coordinates (step S1003). The CPU 14, in this step S1003, executes also a process of acquiring a notifying destination application name of the TC record and stores this application name as an attention focused application name (step S1003). Note that the notifying destination application name of the TC record is coincident with the application name of the CT record. Accordingly, the application name can be also obtained from the CT record.

The CPU 14 having finished the process in step S1003 compares the calculated correction distance with the correction distance upper limit (the upper limit in FIG. 27) (step S1004). If the correction distance is equal to or smaller than the correction distance upper limit (step S1004; YES), the CPU 14 adds in step S1005 the record containing following items of information set in the respective fields to the analysis result table 36.

[“ID” Field]

The “ID” field is entered with the record number before adding the record on the operation history table 36.

[“CORRECTION TARGET” Field]

The “CORRECTION TARGET” field is entered with the “tap coordinates”.

[“APPLICATION NAME” Field]

The “APPLICATION NAME” field is entered with the attention focused application name.

[“CORRECTION VALUE” Field]

The “CORRECTION VALUE” field is entered with the calculated coordinates difference.

In short, the CPU 14 sets the calculated coordinates difference as the correction value, and adds the coordinates correction purposed record with the attention focused application name being set as the application name to the analysis result table 36 (step S1005). Then, the CPU 14 loops back to step S1001 and searches again the operation history table 35 for the TC→CT records.

Whereas if the correction distance is larger than the correction distance upper limit (step S1004; NO), the CPU 14 loops back to step S1001 without executing the process in step S1005.

The CPU 14 iterates the same processes till the unprocessed TC→CT records disappear. Then, the CPU 14, when the unprocessed TC→CT records disappear (step S1002; NO), terminates this coordinates correction information generating process.

As apparent from the description given above, the second coordinates correction information generating process is the process of calculating the correction value (coordinates difference) in the same procedure as that of the first coordinates correction information generating process (FIG. 8). However, the special operation sequence having the contents illustrated in FIG. 10 is carried out, in which case in step S1001 of the second coordinates correction information generating process, there are retrieved the TC→CT (SC→CS) records indicating the contents of the two operations depicted in FIGS. 10(A) and 10(E). Further, as a result, a coordinates difference given by “coordinates of point 54−coordinates of point 52” is recorded as a tap coordinates purposed correction value on the analysis result table 36. It therefore follows that the information processing apparatus 20 can correct the tap coordinates by the value given from “coordinates of point 54−coordinates of point 52” when the special operation sequence in FIG. 10 is carried out.

On the other hand, the information processing apparatus 10 in the first embodiment is the apparatus that corrects, as already described, the tap coordinates only by the value given from “0.5 τ (coordinates of point 54−coordinates of point 52)” when the special operation sequence having the contents illustrated in FIG. 10 is executed. Accordingly, the information processing apparatus 20 according to the second embodiment is capable of correcting the tap coordinates (tap coordinates correction value) more preferably than by the information processing apparatus 10.

Next, content of the second LT threshold correction information generating process (FIG. 24; step S906) will be described.

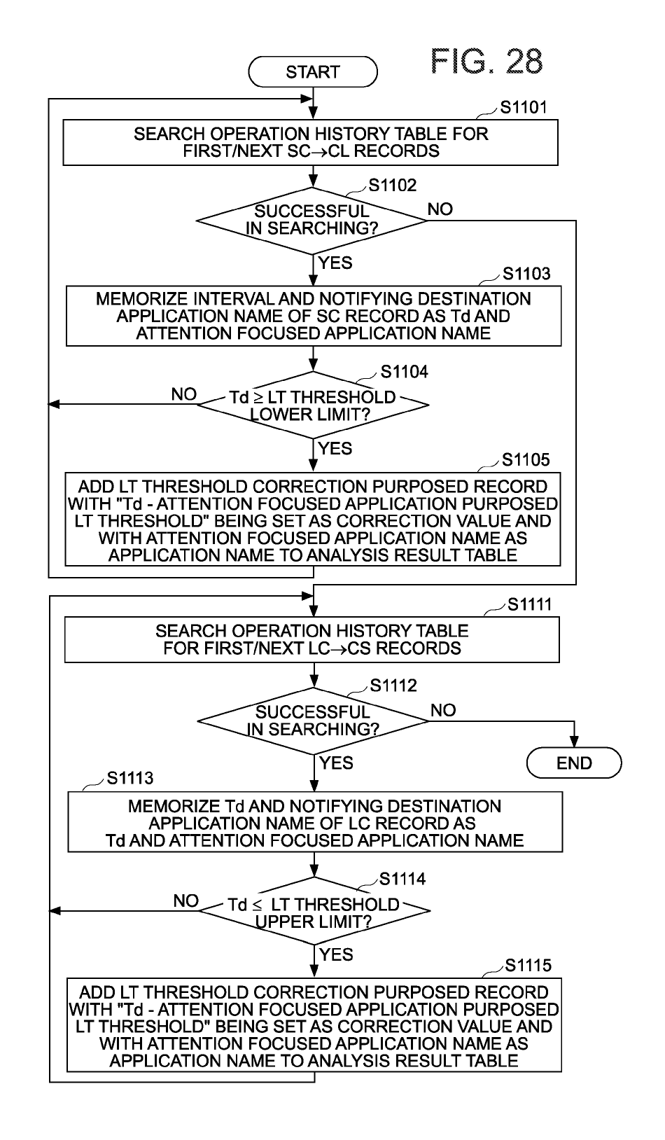

FIG. 28 depicts a flowchart of the second LT threshold correction information generating process.

As illustrated in FIG. 28, the CPU 14, which started the second LT threshold correction information generating process, to begin with, searches the operation history table 35 for the first SC→CL records (step S1101). The SC→CL records searched for in step S1101 are the two records arranged in the sequence of the SC record and the CL record on the operation history table 35.

If the SC→CL records can be retrieved (step S1102; YES), the CPU 14 stores the interval and the notifying destination application name each set in the SC record of the SC→CL records as “Td” and “attention focused application name”, respectively (step S1103).

Subsequently, the CPU 14 determines whether a relation of “Td≧LT threshold lower limit” is established or not (step S1104). If “Td≧LT threshold lower limit” is not established (step S1104; NO), the CPU 14 loops back to step S1101 and retrieves the next SC→CL records from the operation history table 35.

Whereas if “Td≧LT threshold lower limit” is established (step S1104; YES), the CPU 14 adds, to the analysis result table 36, the LT threshold correction purposed record with “Td−attention focused application purposed LT threshold” being set as the correction value (step S1105). Herein, the attention focused application purposed LT threshold connotes the LT threshold used for the attention focused application identified by the attention focused application name. Namely, the attention focused application purposed LT threshold connotes “the LT threshold in the LT threshold standard value+system purposed LT correction value+attention focused application purposed application-by-application correction information 32”.

Note that the LT threshold correction purposed record added to the analysis result table 36 in step S1105 is the record containing the attention focused application name set in the “APPLICATION NAME” field. Further, a reason why not the value given by “Td LT threshold” but the value given by “Td attention focused application purposed LT threshold” is set as the correction value is that the LT threshold changes depending on which application is in the execution underway (FIG. 21) and hence the proper correction cannot be made if using the LT threshold when in the process of step S1105.

The CPU 14 having finished the process in step S1105 loops back to step S1105 and retrieves the next SC→CL records from the operation history table 35.

The CPU 14 repeats the same processes till the unprocessed SC→CL records disappear. Then, the CPU 14, when the unprocessed SC→CL records disappear (step S1102; NO), retrieves the first LC→CS records from the operation history table 35 (step S1111). The LC→CS records retrieved in this step S1111 are the two records arranged in the sequence of the LC record and the CS record on the operation history table 35.

If the LC→CS records can be retrieved (step S1112; YES), the CPU 14 stores the interval and the notifying destination application name in the LC record of the LC→CS records as “Td” and “attention focused application name”, respectively (step S1113). Then, the CPU 14 determines whether a relation of “Td≦LT threshold upper limit” is established or not (step S1114).

The CPU 14, if “Td≦LT threshold upper limit” is not established (step S1114; NO), loops back to step S1111 and searches the operation history table 35 for the next LC→CS records.

Whereas if “Td≧LT threshold upper limit” is established (step S1114; YES), the CPU 14 adds, to the analysis result table 36, the LT threshold correction purposed record with “Td−attention focused application purposed LT threshold” being set in the “CORRECTION VALUE” field (step S1115). Then, the CPU 14 loops back to step S1111 and retrieves the next LC→CS records from the operation history table 35.

The CPU 14 repeats the same processes till the unprocessed LC→CS records disappear. Then, the CPU 14, when the unprocessed LC→CS records disappear (step S1112; NO), terminates this second LT threshold correction information generating process.

This second LT threshold correction information generating process involves, similarly to the first coordinates correction information generating process, calculating the correction value on the basis of the information on the record related to the first operation of the special operation sequence. Then, the information processing apparatus 10 is configured as the apparatus including the case of calculating the correction value on the basis of the information on the record related to the operation not being the first operation of the special operation sequence with respect to the first LT threshold correction information generating process executed by the information processing apparatus 10. Hence, the information processing apparatus 20 according to the second embodiment can be said to be the apparatus capable of correcting the LT threshold more preferably than by the information processing apparatus 10.

Next, content of the second DT threshold correction information generating process will be described.

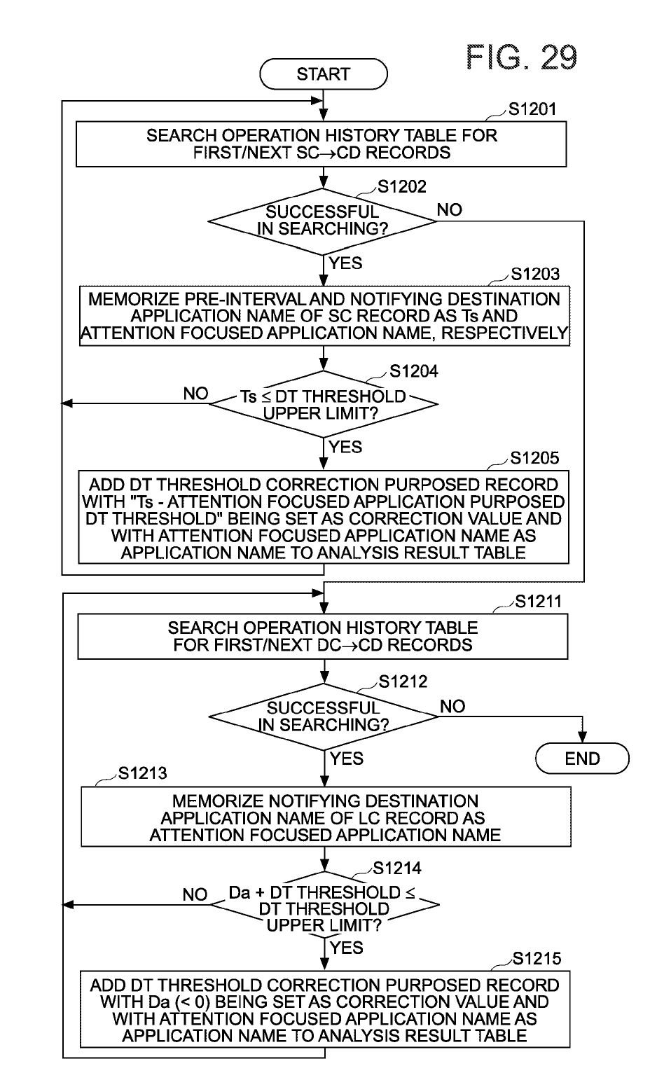

FIG. 29 illustrates a flowchart of the second DT threshold correction information generating process. Note that this second DT threshold correction information generating process is the same as the first DT threshold correction information generating process in terms of the correction value calculation procedure thereof.

As depicted in FIG. 29, the CPU 14 (OS 22), which has started the second DT threshold correction information generating process, at first searches the operation history table 35 for the first SC→CD records (step S1201). Herein, the SC→CD records are the two records arranged in the sequence of the SC record with the pre-interval being set and the CD record on the operation history table 35. Incidentally, a reason why to set a condition “the pre-interval being set” is that if this condition is set, as already described, “the record representing the content of the SS operation” can be searched for.

If the SC→CD records can be retrieved (step S1202; YES), the CPU 14 stores, as “Ts”, the pre-interval of the SC record retrieved as the element of the SC→CD records (step S1203). Furthermore, the CPU 14 stores the notifying destination application name of the SC record as the attention focused application name (step S1203).

Subsequently, the CPU 14 determines whether a relation of “Ts≦DT threshold upper limit” is established or not (step S1204).

If “Ts≦DT threshold upper limit” is established (step S1204; YES), the CPU 14 sets “Ts−attention focused application purposed DT threshold” as the correction value, and adds the DT threshold correction purposed record with the “attention focused application name” being set as the application name to the analysis result table 36 (step S1205).

Then, the CPU 14 having finished the process in step S1205 loops back to step S1201, and searches the operation history table 35 for the next SC→CD records.

Whereas if “Ts≦DT threshold upper limit” is not established (step S1204; NO), the CPU 14 loops back to step S1201 without executing the process in step S1205.

The CPU 14 repeats the same processes till the unprocessed SC→CD records disappear. Then, the CPU 14, when the unprocessed SC→CD records disappear (step S1202; NO), retrieves the DC→CS records from the operation history table 35 (step S1211).

The DC→CS records are the two records arranged in the sequence of the DC record and the CS record with the post-interval being set on the operation history table 35. Incidentally, a reason why to set a condition “the post-interval being set” lies in searching for the CS record related to the first operation of the SS operation. To be specific, the post-interval is set in the S record in a case where the next record is the C record or the C record (see FIG. 23). Then, the CS record is the record with the next record not being the C record (see FIG. 24). Accordingly, if searching for the CS record with the post-interval being set, it follows that it is feasible to search for the CS record with the next record being the S record, i.e., the CS record related to the first operation of the SS operation.

If the DC→CS records can be retrieved (step S1212; YES), the CPU 14 stores, as the attention focused application name, the notifying destination application name of the DC record retrieved as the element of the DC→CS records (step S1213).

Thereafter, the CPU 14 determines whether a relation of “Da+DT threshold≦DT threshold upper limit” is established or not (step S1214). Then, the CPU 14, if “Da+DT threshold≦DT threshold upper limit” is not established (step S1214; NO), loops back to step S1211.

The CPU 14, whereas if “Da+DT threshold≦DT threshold upper limit” is established (step S1214; YES), sets “Da” as the correction value and adds the DT threshold correction purposed record with the attention focused application name being set as the application name to the operation history table 35 (step S1214). Subsequently, the CPU 14 having finished the process in step S1214 loops back to step S1211.

The CPU 14 repeats the same processes till the unprocessed DC→CS records disappear. Then, the CPU 14, when the unprocessed DC→CS records disappear (step S1202; NO), terminates this DT threshold correction information generating process.

Referring back to FIG. 24, remaining steps of the second correction information update process will be described.

The CPU 14 (OS 22) having finished the three types of correction information generating processes (step S905-S907) calculates the average value of the correction values on the analysis result table 36 on a per correction target identifier basis (step S908). That is, the CPU 14 calculates an average value (an average value of the x-directional coordinate differences and an average value of the y-directional coordinate differences) of the correction values of the coordinates correction purposed record, an average value of the correction values of the LT threshold correction purposed record and an average value of the correction values of the DT threshold correction purposed record.

Then, the CPU 14 adds a half (½) of the average value calculated from the correction values of the coordinates correction purposed record to the system purposed coordinates correction value (the coordinates correction value in the system purposed correction information 31 (FIG. 18) (step S908). Moreover, the CPU 14 adds a half (½) of the average value calculated from the correction values of the LT threshold correction purposed record to the system purposed LT correction value, and also adds a half (½) of the average value calculated from the correction values of the DT threshold correction purposed record to the system purposed DT correction value (step S908).

Furthermore, the CPU 14 determines in step S908 whether or not the post-updating system purposed coordinates correction value is a value within a preset coordinates correction range (a circular range in the second embodiment). Then, the CPU 14, if being the value beyond the coordinates correction range, changes this value to a value on a borderline of the coordinates correction range by shifting the system purposed coordinates correction values (the x- and y-directional correction values) toward (0, 0).

The CPU 14 having finished the process in step S908 calculates the average value of the correction values on the analysis result table 36 on the per correction target identifier basis and on a per application name basis (on a combination-by-combination basis of the correction target identifier and the application name) (step S909). Then, the CPU 14 adds a half (½) of the calculated average value to the corresponding application purposed correction value on the RAM 16 (on the ROM 15 if not on the RAM 16) (step S909). Note that the “corresponding application purposed correction value” connotes the coordinates correction value, the LT correction value or the DT correction value in the corresponding application purposed application-by-application correction information 32.

Moreover, the CPU 14 determines in step S909 whether or not each post-updating application purposed coordinates correction value is a value within the coordinates correction range. Then, the CPU 14 changes each application purposed coordinates correction value taking the value beyond the coordinates correction range to a value on the borderline of the coordinates correction range by shifting the application purposed coordinates correction range toward (0, 0).

The CPU 14 having finished the process in step S909 clears the analysis result table 36 and the operation history table 35 (step S910). Subsequently, the CPU 14 finishes this correction information update process and comes to the status of monitoring if a predetermined or more number of records are added to the operation history table 35 while executing the operation distinguishing process.

As described above in detail, each of the information processing apparatuses 10 and 20 (OS 21, OS 22) according to the first and second embodiments has the functions of recording the user's operation history, specifying the operation sequence such as “tap operation→cancelling operation within short time→tap operation within short time”, and updating the coordinates correction value that specifies the correction quantity of the tap coordinates, the LT threshold and the DT threshold into the values more suited to the user on the basis of the result of specifying the operation sequence.

It therefore follows that the user of each of the information processing apparatuses 10 and 20 according to the first and second embodiments may not perform the setting operation of the touch panel parameters such as the coordinates correction value by use of the setting screen.

Moreover, the information processing apparatus 20 according to the second embodiment specifies the special operation sequence starting with the first operation and ending with the final operation, and updates the coordinates correction value etc. into the values more suited to the user on the basis of the specifying result thereof. Then, the first operation is the normal tap operation of the user, and hence the information processing apparatus 20 can be said to be the apparatus capable of correcting the coordinates correction value etc. more preferably than by the information processing apparatus 10 including the case of updating the coordinates correction value etc. from the three operations not containing the first operation.

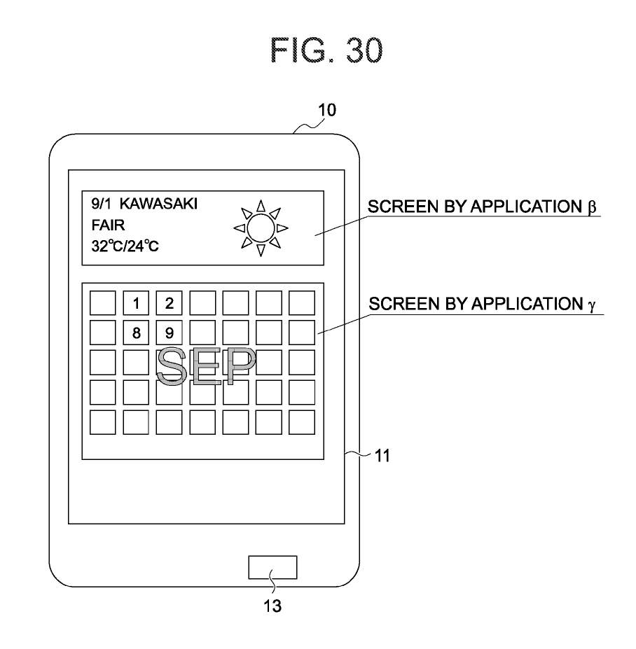

Moreover, the information processing apparatus 20 (OS 22) corrects each touch panel parameter by use of the operation target application purposed correction value and the system purposed correction value (see FIG. 21). Therefore, the information processing apparatus 20 can be operated in the status of not determining that the touch panel is not double-tapped even when tapping fast consecutively during the execution of the specified application (e.g., a game application) but determining that the touch panel is double-tapped by the operations with the normal tap interval during the execution of other categories of applications. Further, the use of the information processing apparatus 20 enables the mis-recognition not to be made even when tapping the portions in the vicinities of the borders of the respective applications if the screens of two types of applications β, γ are, as schematically illustrated in FIG. 30, displayed on the touch panel 11.

### Modified Examples

The information processing apparatuses 10 and 20 (OS 21, OS 22) according to the first and second embodiments can be modified in a variety of forms. For example, each of the information processing apparatuses 10 and 20 (OS 21, OS 22) can be modified into an apparatus configured only to correct the tap coordinates and only to correct the LT (long tap) threshold. Moreover, the information processing apparatus 10 can be modified into an apparatus configured to execute the correction information update process (FIG. 7) and the process in step S112 (FIG. 5) through the application programs.

The information processing apparatus 20 can be also modified into an apparatus configured to manage the system purposed correction information 31 and the application-by-application correction information 32 with each correction value being twice as large as the value described above, to make use of the application purposed application-by-application correction information 32 for the application already prepared with the application-by-application correction information 32, and to make use of the system purposed correction information 31 for the application not prepared with the application-by-application correction information 32.

Each of the information processing apparatuses 10 and 20 can be also modified into an apparatus configured to determine only a correcting direction (two-dimensional directions with respect to the tap coordinates, and a one-dimensional direction with respect to the LT threshold and the DT threshold) for each correction target and to correct the correction target by only a fixed quantity in the determined direction. Furthermore, the information processing apparatus 10 can be also modified into an apparatus configured to add not the average value of the correction values with respect to each correction target but a maximum value of the correction values with respect to each correction target on the analysis result table 34 to each correction value in the correction information 30. As a matter of course, the same modifications can be applied to the information processing apparatus 20.

Each of the information processing apparatuses 10 and 20 can be modified into an apparatus configured to specify the operation sequence such as “tap operation→cancelling operation within predetermined time→tap operation thereafter”, to obtain the correction quantity of the touch panel parameter (tap coordinates correction quantity etc.) on the basis of the content of the operation sequence, and to actually correct the touch panel parameter if the obtained correction quantity does not take an abnormal value.

Moreover, each of the information processing apparatuses 10 and 20 is the apparatus configured so that the pressing operation of the back button 13 functions as the cancelling operation, however, the cancelling operation may be sufficient if manipulating some kind of an item. Accordingly, each of the information processing apparatuses 10 and 20 can be also modified into an apparatus configured so that the back button 13 is a button displayed on the touch screen 11. Further, each of the OS 21 and the OS 22 may be recorded on a portable recording medium such as a CD-ROM (Compact Disc Read-Only Memory) and thus distributed. Still further, it is a matter of course that the first specified time etc. may take a value different from the value described above and that each of the information processing apparatuses 10 and 20 may be modified into an apparatus (e.g., a tablet PC) configured to have specific hardware architecture different from the architecture described above.

Furthermore, with regard to the above technology, the following note is disclosed.

(Note 1) An information processing apparatus, comprising:

a touch panel;

an item to get a screen previous to a screen at a present point of time to be displayed on the touch panel;

an operation history information storage unit; and

a control unit to execute an application utilizing the touch panel as an input/output device,

wherein the control unit executes:

an operation history storing process of storing, when a tap operation on the touch panel or an operation to the item is performed, operation history information indicating a type of the performed operation and time when the operation is performed on the operation history information storage unit; and

a touch panel parameter update process of specifying an operation sequence in which a time interval between a first operation and a second operation is equal to or smaller than a specified period of time and in which the first operation defined as the tap operation, the second operation defined as the operation to the item and a third operation defined as the tap operation are conducted in this sequence, from within the operation sequences conducted by a user on the basis of pieces of operation history information stored on the operation history information storage unit, and updating a time threshold for distinguishing between types of the tap operations performed on the touch panel on the basis of the result of specifying the operation sequence.

(Note 2) An information processing apparatus, comprising:

a touch panel;

an item to get a screen previous to a screen at a present point of time to be displayed on the touch panel;

an operation history information storage unit; and

a control unit to execute an application utilizing the touch panel as an input/output device,

wherein the control unit executes:

an operation history storing process of storing, when performing a tap operation on the touch panel or operation to the item, operation history information indicating a type of the performed operation and time when performing the operation on the operation history information storage unit; and

a touch panel parameter update process of specifying operation history information on a initial tap operation conducted by a user as a starting instruction of a process and operation history information on a final tap operation conducted by the user as a result of mis-recognizing of the initial tap operation from the operation history information stored on the operation history information storage unit, and updating a correction quantity of tap coordinates of the tap operation performed on the touch panel on the basis of the result of specifying the operation sequence.

(Note 3) An information processing apparatus, comprising:

a touch panel;

an item to get a screen previous to a screen at a present point of time to be displayed on the touch panel;

an operation history information storage unit; and

a control unit to execute an application utilizing the touch panel as an input/output device,

wherein the control unit executes:

an operation history storing process of storing, when performing a tap operation on the touch panel or operation to the item, operation history information indicating a type of the performed operation and time when performing the operation on the operation history information storage unit; and

a touch panel parameter update process of specifying operation history information on a initial tap operation conducted by a user as a starting instruction of a process and operation history information on a final tap operation conducted by the user as a result of mis-recognizing of the initial tap operation from the operation history information stored on the operation history information storage unit, and updating a time threshold for distinguishing between types of the tap operations performed on the touch panel on the basis of the result of specifying the operation sequence.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

1. An information processing apparatus, comprising:
a touch panel;
an item to get a screen previous to a screen at a present point of time to be displayed on the touch panel;
an operation history information storage unit; and
a control unit to execute an application utilizing the touch panel as an input/output device,
wherein the control unit executes:
an operation history storing process of storing, when a tap operation on the touch panel or an operation to the item is performed, operation history information indicating a type of the performed operation and time when the operation is performed on the operation history information storage unit; and
a touch panel parameter update process of specifying an operation sequence in which a first operation defined as a tap operation, a second operation defined as an operation to the item and a third operation defined as another tap operation are conducted in this sequence and in which a time interval between the first operation and the second operation is equal to or smaller than a specified period of time, from within operation sequences conducted by a user on the basis of pieces of operation history information stored on the operation history information storage unit, and updating a correction quantity of tap coordinates of the tap operation performed on the touch panel on the basis of the result of specifying the operation sequence.

2. The information processing apparatus according to claim 1, wherein the touch panel parameter update process is a process of specifying a first type operation sequence with the first operation and the third operation being the same type of tap operations, and a second type operation sequence with the first operation and the third operation being different types of tap operations by way of the operation sequence, and updating the correction quantity on the basis of the result of specifying the first type operation sequence and also a time threshold for distinguishing between the types of the tap operations performed on the touch panel on the basis of the result of specifying the second type operation sequence.

3. The information processing apparatus according to claim 1, wherein the control unit further executes a determination process of calculating temporary coordinates by correcting the tap coordinates on the touch panel on the basis of a system purposed coordinates correction value; specifying an application with the tap operation being performed from within applications in execution underway on the basis of the calculated temporary coordinates; calculating post-correcting coordinates by correcting the tap coordinates on the touch panel on the basis of an application-by-application coordinates correction value for the specified application and the system purposed coordinates correction value, and determining which object in the specified application based on the post-correcting coordinates is tapped,
the operation history storing process is a process of storing onto the operation history information storage unit the operation history information containing identifying information of the application specified by the determining process and the post-correcting coordinates calculated by the determining process with respect to each tap operation, and
the touch panel parameter update process is a process of updating, as the correction quantity, the system purposed coordinates correction value and one or more application-by-application coordinates correction values, and is also a process of updating the system purposed coordinates correction value by processing the operation history information related to the first operation and the third operation by a first algorithm with respect to the specified operation sequence, and updating the application-by-application coordinates correction value for each application by processing the operation history information related on the first operation and the third operation on a per identifying information basis of the application contained in the first operation or the third operation by the first algorithm with respect to the specified operation sequence.

4. The information processing apparatus according to claim 2, wherein the control unit further executes a determination process of: calculating temporary coordinates by correcting the tap coordinates on the touch panel on the basis of a system purposed coordinates correction value; specifying an application with the tap operation being performed from within applications in execution underway on the basis of the calculated temporary coordinates; calculating post-correcting coordinates by correcting the tap coordinates on the touch panel on the basis of an application-by-application coordinates correction value for the specified application and the system correction value; determining which object in the specified application based on the calculated post-correcting coordinates is tapped; and further determining a type of the tap operation performed on the touch panel by use of an application-by-application time threshold for the specified application and a system purposed time threshold,
the operation history storing process is a process of storing onto the operation history information storage unit a tap time, the operation history information containing identifying information of the application specified by the determining process and the post-correcting coordinates calculated by the determining process with respect to each tap operation, and
the touch panel parameter update process is a process of updating, as the correction quantity, the system purposed coordinates correction value and one or more application-by-application coordinates correction values, and updating, as the time threshold, the system purposed time threshold and one or more application-by-application time thresholds, and is also a process of updating the system purposed coordinates correction value by processing the operation history information related to the first operation and the third operation by a first algorithm with respect to the specified first type operation sequence, updating the application-by-application coordinates correction value for each application by processing the operation history information related on the first operation and the third operation on a per identifying information basis of the application contained in the first operation or the third operation by the first algorithm with respect to the specified first type operation sequence, updating the system purposed time threshold by processing the operation history information related to the first operation and the third operation by a second algorithm with respect to a specified second type operation sequence, and updating the application-by-application time threshold for each application by processing the operation history information related to the first operation and the third operation on the per identifying information of the application contained in the first operation or the third operation by the second algorithm with respect to the specified first type operation sequence.

5. The information processing apparatus according to claim 1, wherein the touch panel parameter update process is a process of specifying the operation sequence in which the time interval between the first operation and the second operation is equal to or smaller than the specified period of time and in which the time interval between the second operation and the third operation is equal to or smaller than a second specified period of time.

6. A touch panel parameter update method of an information processing apparatus including a touch panel and an item to get a screen previous to a screen at a present point of time to be displayed on the touch panel,
a processor executing:
storing, when a tap operation on the touch panel or an operation to the item is performed, operation history information indicating a type of the performed operation and time when the operation is performed on an operation history information storage unit;
specifying an operation sequence in which a first operation defined as a tap operation, a second operation defined as an operation of the item and a third operation defined as another tap operation are conducted in this sequence and in which a time interval between the first operation and the second operation is equal to or smaller than a specified period of time, from within operation sequences conducted by a user on the basis of pieces of operation history information stored on the operation history information storage unit; and
updating a correction quantity of the tap coordinates of the tap operation performed on the touch panel on the basis of the result of specifying the operation sequence.

7. A computer-readable recording medium having stored therein a program for causing an information processing apparatus including a touch panel, an item to get a screen previous to a screen at a present point of time to be displayed on the touch panel and a storage device to execute a process comprising:
storing, when a tap operation on the touch panel or an operation to the item is performed, operation history information indicating at least a type of the performed operation and time when the operation is performed on the storage device;
specifying an operation sequence in which a first operation defined as a tap operation, a second operation defined as an operation to the item and a third operation defined as another tap operation are conducted in this sequence and in which a time interval between the first operation and the second operation is equal to or smaller than a specified period of time, from within operation sequences conducted by the user on the basis of pieces of operation history information stored on the storage device; and
correcting a coordinates correction value for specifying a correction quantity of tap coordinates of the tap operation performed on the touch panel on the basis of the result of specifying the operation sequence.
